(19) United States
(12) Patent Application Publication
(10) Pub. No.: US 2026/0057142 A1
(43) Pub. Date: Feb. 26, 2026

(54) FORCE MEASUREMENT SYSTEM, STRUCTURE OPTIMIZATION METHOD AND APPARATUS OF FORCE MEASUREMENT SYSTEM AND STRUCTURE OPTIMIZATION METHOD AND APPARATUS OF FORCE MEASUREMENT BRANCHES

(71) Applicant: CHINA ACADEMY OF MACHINERY ZHENGZHOU RESEARCH INSTITUTE OF MECHANICAL ENGINEERING CO., LTD., Henan (CN)

(72) Inventors: Dong LI, Henan (CN); Guoliang ZHENG, Henan (CN); Leile ZHANG, Henan (CN); Qianli MA, Henan (CN)

(73) Assignee: CHINA ACADEMY OF MACHINERY ZHENGZHOU RESEARCH INSTITUTE OF MECHANICAL ENGINEERING CO., LTD., Henan (CN)

(21) Appl. No.: 19/305,719

(22) Filed: Aug. 20, 2025

(30) Foreign Application Priority Data
Aug. 23, 2024 (CN) 202411168753.3

(51) Int. Cl. G06F 30/23; G06F 111/10; G06F 119/14

(52) U.S. Cl. CPC G06F 30/23; G06F 2111/10; G06F 2119/14

(57) ABSTRACT

The main structure optimization of the force measurement system is divided into three parts: structure parameter optimization of force measurement branches, structure parameter optimization of non-branch structures, and structure parameter fine-tuning of the entire force measurement system. Quantitative design is performed on each part to improve the design efficiency and accuracy of the force measurement system. During the quantitative design process of each part, an elastic resistance error is treated as a forward design indicator and is one of the main components in a coupling error. The structure parameters involved in the elastic resistance error are relatively comprehensive, and the elastic resistance error is considerably correlated with the structure parameters of the force measurement system in consideration of the influence of axial stiffness and lateral deviation stiffness of force measurement on the structural performance. The accuracy of structural analysis and design are thus ensured.

### CROSS-REFERENCE TO RELATED APPLICATION

This application claims the priority benefit of China application serial no. 202411168753.3, filed on Aug. 23, 2024. The entirety of the above-mentioned patent application is hereby incorporated by reference herein and made a part of this specification.

### TECHNICAL FIELD

The disclosure belongs to the technical field of force measurement system optimization, and specifically relates to a force measurement system, a structure optimization method and apparatus of the force measurement system, and a structure optimization method and apparatus of force measurement branches.

### BACKGROUND

At present, with the advancement of aerospace vector thrust technology and the rapid development in industrial automation, precision manufacturing, robotics and other fields, the demand for high-precision vector force measurement systems is increasing. In the aerospace field, related equipment (referred to as vector force measurement systems, test stands, six-component balances, box balances, force measurement systems, etc.) is key equipment for measuring engine thrust or model loading in the aerospace field. With the increasing requirements of vector thrust technology for new generation fighter aircraft and the development of wind tunnel load measurement technology, the demand for high-precision and heavy-load vector thrust measurement systems is becoming increasingly urgent. Applications in robotics and other fields mostly use small vector force measurement systems, commonly referred to as force sensors, six-dimensional force sensors, 6-axis force/torque sensors, etc., which are among the key sensors in the robotics field. At present, high-precision small vector force measurement systems have huge market demand, so exploring high-precision design technology for vector force measurement systems has important significance.

At present, theoretical research on force measurement system structure design mainly focuses on sensitivity analysis and isotropic design, with theoretical foundations mostly built on two basic assumptions: first, it assumes that force measurement branches only bear loads in the axial direction; second, it idealizes non-branch structures such as moving frames and supports as rigid bodies without deformation. Under these simplified theoretical assumptions, design work focuses on optimizing the layout and axial stiffness of branches in a force measurement system, so as to achieve enhanced structural sensitivity and isotropic characteristics. This process derives many design conclusions with practical value. However, this method constrains the structural design of force measurement systems to a certain extent because it ignores the influence of key structural characteristics such as the lateral stiffness of force measurement branches and the non-branch structure stiffness of branches in a non-force measurement in the system.

In the current structural design practice of force measurement systems, finite element models are widely adopted as the main tool. The typical design process includes designers preliminarily formulating the basic structural framework, subsequently utilizing finite element analysis technology to conduct detailed design of the core component-force measurement branches, and carrying out strength and frequency evaluation of important non-branch structures such as moving frames and supports. This method is able to basically meet practical requirements. However, this design method particularly relies on designers' rich professional experience and fails to fully optimize structural parameter configuration from the perspective of overall system performance. Another design method involves the use of finite element analysis software to create relatively accurate simulation models, the geometric characteristics and layout parameters of force measurement branches are continuously adjusted, and comprehensive parameter iterative optimization is conducted until key performance indicators such as system stiffness meet standards. This structural design approach based on parameter optimization can usually achieve favorable results. However, this process highly depends on massive computational resources and requires designers to execute complex and time-consuming analysis workflows.

Force measurement branches, as important structures in force measurement systems, require crucial structural optimization design. Generally, coupling error is widely used as one of the key indicators of force measurement systems to reflect the measurement performance of force measurement branches in force measurement systems. However, coupling error has many sources and is influenced by multiple factors. In addition to system structural factors, there are also coupling errors caused by processing and assembly errors, coupling errors caused by material characteristics, electrical coupling errors, and coupling errors between data acquisition channels. Further, the sensitivity of diagonal elements and non-diagonal elements in coupling errors to various interferences is unclear. This multi-factor and sensitivity-ambiguous situation makes it unsuitable to be directly used as a structural design indicator, resulting in poor structural forward design effects, and the further development of vector force measurement technology is thus constrained.

### SUMMARY

The disclosure aims to provide a force measurement system, structure optimization method and apparatus of the force measurement system, structure optimization method and apparatus of force measurement branches, so as to solve the problem of poor structural forward design effect caused by using a coupling error as an indicator.

To solve the above technical problem, the disclosure provides a structure optimization method of force measurement branches in a force measurement system, and the method includes the following steps.
1) A simulation model of the force measurement branches is constructed according to initial structure parameters of the force measurement branches.
2) It is judged whether force measurement branch indicators meet a standard by using the latest simulation model of the force measurement branches, if not the structure parameters of the force measurement branches are adjusted to lower the force measurement branch indicators, the simulation model of the force measurement branches are re-determined, and step 2) is re-executed for iteration until the standard is met.

The force measurement branch indicators are elastic resistance error coefficients ignoring deformation factors in three directions. The elastic resistance error coefficient ignoring the deformation factor in a specific direction is a sum of the elastic resistance error coefficients ignoring the deformation factors generated by the force measurement branches in the other two directions on the force measurement in the specific direction, and the elastic resistance error coefficient ignoring the deformation factor generated by a force measurement branch in one of the other two directions on the force measurement in the specific direction is a product of a number ratio of the force measurement branch in the one of the other two directions to the force measurement branch in the specific direction, an axial stiffness ratio of the force measurement branch in the one of the other two directions to the force measurement branch in the specific direction, and a ratio of lateral deviation stiffness of the force measurement branch in the one of the other two directions to axial stiffness of the force measurement branch in the one of the other two directions.

Further, the simulation model is a finite element simulation model.

To solve the above technical problems, the disclosure further provides a computer apparatus including a processor executing a computer program to implement the steps of the structure optimization method of the force measurement branches in the force measurement system as described above.

The disclosure is an improved invention. In the structure optimization method of the force measurement branches in the force measurement system and the computer apparatus provided by the disclosure, considering an elastic resistance error is one of the main components of a coupling error, the structure parameters involved in the elastic resistance error are relatively comprehensive, the influences of axial stiffness and lateral deviation stiffness of force measurement on the structure performance, as well as the high correlation between the elastic resistance error and the design parameters of a force measurement system, the elastic resistance error is treated as an evaluation indicator for structure design in the disclosure, so as to improve the accuracy of structure design. Moreover, in the process of optimizing the structure of force measurement branches in the force measurement system, elastic resistance error coefficients that ignore deformation factors are adopted, so that the efficiency of subsequent structure design and optimization of the entire force measurement system may be improved. In addition, the disclosure is a general structure design method that combines the elastic resistance error and simulation, so that the advantages of theoretical methods in analyzing the relationship between structure performance and design parameters, as well as models in precise calculation of deformation and local loads are fully utilized.

To solve the above technical problem, the disclosure further provides a structure optimization method in a force measurement system, and the method includes the following steps.
1) A simulation model of force measurement branches in the force measurement system is constructed according to initial structure parameters of the force measurement branches.
2) It is judged whether force measurement branch indicators meet a standard by using the latest simulation model of the force measurement branches, if not, the structure parameters of the force measurement branches are adjusted to lower the force measurement branch indicators, the simulation model of the force measurement branches is re-determined, and step 2) is re-executed for iteration until the standard is met; if the standard is met, step 3) is executed.

The force measurement branch indicators are elastic resistance error coefficients ignoring deformation factors in three directions. The elastic resistance error coefficient ignoring the deformation factor in a specific direction is a sum of the elastic resistance error coefficients ignoring the deformation factors generated by the force measurement branches in the other two directions on the force measurement in the specific direction, and the elastic resistance error coefficient ignoring the deformation factor generated by a force measurement branch in one of the other two directions on the force measurement in the specific direction is a product of a number ratio of the force measurement branch in the one of the other two directions to the force measurement branch in the specific direction, an axial stiffness ratio of the force measurement branch in the one of the other two directions to the force measurement branch in the specific direction, and a ratio of lateral deviation stiffness of the force measurement branch in the one of the other two directions to axial stiffness of the force measurement branch in the one of the other two directions.
3) A simulation model of the force measurement system is constructed according to initial structure parameters of non-branch structures and the structure parameters of the force measurement branches finally determined in step 2). The non-branch structures are structures in the force measurement system other than the force measurement branches.
4) It is judged whether non-branch structure indicators meet the standard by using the latest simulation model of the force measurement system: if not, the structure parameters of the non-branch structures are adjusted, the simulation model of the force measurement system is re-determined, and step 4) is re-executed for iteration until the non-branch structure indicators meet the standard.

Further, each non-branch structure indicator in step 4) is a non-branch structure evaluation coefficient in each direction, and the non-branch structure evaluation coefficient in a specific direction is a difference value between the elastic resistance error coefficient considering the deformation factors in the specific certain direction and the elastic resistance error coefficient ignoring the deformation factors in the specific direction.

The elastic resistance error coefficient considering the deformation factors in a specific direction is a sum of the elastic resistance error coefficients considering the deformation factors generated by the force measurement branches in the other two directions on the force measurement in the specific direction, and the elastic resistance error coefficient considering the deformation factors is:

$$\begin{matrix}{T}_{fi , ji} = \frac{{n}_{j}}{{n}_{i}} \frac{{K}_{fj , uj}}{{K}_{fi , ui}} ( \frac{{K}_{fi , uj}}{{K}_{fj , uj}} \frac{{\overline{u}}_{Gi , j}}{{\overline{u}}_{Gi , i}} + \frac{{K}_{fk , θ j}}{{K}_{fj , uj}} \frac{{\overline{θ}}_{Gk , j}}{{\overline{u}}_{Gi , i}} ) & i , j , k ∈\end{matrix} \{ \begin{matrix}x & y & z\end{matrix} \} , i \neq j \neq k ,$$

where T_{fi,ji} represents the elastic resistance error coefficient generated by the i-direction force measurement branch on the force measurement in a y direction, nᵢ represents the number of i-direction force measurement branches, nⱼ represents the number of j-direction force measurement branches, K_{fi,ui} represents i-direction displacement stiffness caused by an i-direction force component of the i-direction force measurement branch in a global coordinate system and referred to as axial stiffness of the i-direction force measurement branch, K_{fj,uj} represents j-direction displacement stiffness caused by a j-direction force component of the j-direction force measurement branch in the global coordinate system and referred to as axial stiffness of the j-direction force measurement branch, K_{fi,uj} represents i-direction displacement stiffness caused by an i-direction force component of the j-direction force measurement branch in the global coordinate system and referred to as axial stiffness of the j-direction force measurement branch, K_{fk,θj} represents bending stiffness surrounding a k direction caused by a moment component of the j-direction force measurement branch surrounding the k direction in the global coordinate system, ū_{Gi,i} represents an average value of i-direction displacement of the i-direction force measurement branch under the global coordinate system, ū_{Gi,j} represents an average value of i-direction displacement of the j-direction force measurement branch under the global coordinate system, and θ̅_{Gk,j} represents an average value of the j-direction force measurement branch bending surrounding the k direction under the global coordinate system.

The non-branch structure indicators meeting the indicator requirements means that the non-branch structure evaluation coefficients in all directions are less than a set evaluation threshold.

Further, the elastic resistance error coefficient considering the deformation factor in a specific direction is a load-to-measurement ratio in that specific direction minus 1, and the load-to-measurement ratio is a ratio of an applied load to the force component synthesized by the force measurement branches.

Further, the method also includes the following steps.
5) A simulation model of the force measurement system is determined using the structure parameters of the force measurement system finally determined in step 4).
6) It is evaluated whether stability of the force measurement system satisfies stability requirements by using the latest simulation model of the force measurement system: if satisfied, structure optimization of the entire force measurement system is completed; if not satisfied, the structure parameters of the force measurement system is fine-tuned, the simulation model of the force measurement system is re-determined using the fine-tuned structure parameters, and step 6) is re-executed for iteration until the stability of the force measurement system satisfies the stability requirements.

Further, in step 3) the stability is evaluated according to a deformation ratio matrix, and the deformation ratio matrix is:

$$U = [ \begin{matrix}{\overline{u}}_{Gy , x} / {\overline{u}}_{Gx , x} & {\overline{θ}}_{Gy , x} / {\overline{u}}_{Gx , x} & {\overline{u}}_{Gz , x} / {\overline{u}}_{Gx , x} & {\overline{θ}}_{Gz , x} / {\overline{u}}_{Gx , x} \\ {\overline{u}}_{Gx , y} / {\overline{u}}_{Gy , y} & {\overline{θ}}_{Gx , y} / {\overline{u}}_{Gy , y} & {\overline{u}}_{Gz , y} / {\overline{u}}_{Gy , y} & {\overline{θ}}_{Gz , y} / {\overline{u}}_{Gy , y} \\ {\overline{u}}_{Gx , z} / {\overline{u}}_{Gz , z} & {\overline{θ}}_{Gx , z} / {\overline{u}}_{Gz , z} & {\overline{u}}_{Gy , z} / {\overline{u}}_{Gz , z} & {\overline{θ}}_{Gy , z} / {\overline{u}}_{Gz , z}\end{matrix} ]$$

$$Or$$

$${U}_{e} = [ \begin{matrix}{\overline{u}}_{Gx , x} / {\overline{u}}_{Gx , x} & {\overline{u}}_{Gx , y} / {\overline{u}}_{Gx , x} & {\overline{u}}_{Gx , z} / {\overline{u}}_{Gx , x} \\ {\overline{u}}_{Gy , x} / {\overline{u}}_{Gy , y} & {\overline{u}}_{Gy , y} / {\overline{u}}_{Gy , y} & {\overline{u}}_{Gy , z} / {\overline{u}}_{Gy , y} \\ {\overline{u}}_{Gz , x} / {\overline{u}}_{Gz , z} & {\overline{u}}_{Gz , y} / {\overline{u}}_{Gz , z} & {\overline{u}}_{Gz , z} / {\overline{u}}_{Gz , z}\end{matrix} ] ,$$

where U and Uₑ both represent deformation ratio matrices, ū_{Gy,x} represents the average value of the y-direction displacement of the x-direction force measurement branch in the global coordinate system, ū_{Gx,x} represents the average value of the x-direction displacement of the x-direction force measurement branch in the global coordinate system, ū_{Gx,y} represents the average value of the x-direction displacement of the y-direction force measurement branch in the global coordinate system, ū_{Gy,y} represents the average value of the y-direction displacement of the y-direction force measurement branch in the global coordinate system, ū_{Gx,z} represents the average value of the x-direction displacement of the z-direction force measurement branch in the global coordinate system, ū_{Gz,z} represents the average value of the z-direction displacement of the z-direction force measurement branch in the global coordinate system, θ̅_{Gy,x} represents the average value of the x-direction force measurement branch bending surrounding the y direction in the global coordinate system, θ̅_{Gx,y} represents the average value of the y-direction force measurement branch bending surrounding the x direction in the global coordinate system, θ̅_{Gx,z} represents the average value of the z-direction force measurement branch bending surrounding an x direction in the global coordinate system, ū_{Gz,x} represents the average value of the z-direction displacement of the x-direction force measurement branch in the global coordinate system, ū_{Gz,y} represents the average value of the z-direction displacement of the y-direction force measurement branch in the global coordinate system, ūGy,z represents the average value of the y-direction displacement of the z-direction force measurement branch in the global coordinate system, θ̅_{Gz,x} represents the average value of the x-direction force measurement branch bending surrounding a z direction in the global coordinate system, θ̅_{Gz,y} represents the average value of the y-direction force measurement branch bending surrounding the z direction in the global coordinate system, and θ̅_{Gy,z} represents the average value of the z-direction force measurement branch bending surrounding the y direction in the global coordinate system.

In the deformation ratio matrix Uₑ, the closer each element in the matrix is to 1, the better the stability of the force measurement system, in the deformation ratio matrix U, the closer the elements in a first column and a third column are to 1 and the closer the elements in a second column and a fourth column are to 0, the better the stability of the force measurement system.

Further, the method of evaluating the stability according to the deformation ratio matrix is as follows.

A trace or a norm of the deformation ratio matrix Uₑ is calculated, and a trace or a norm of U₁ is correspondingly subtracted from the trace or the norm of the deformation ratio matrix Uₑ, to obtain a corresponding difference value. U₁ is an ideal deformation ratio matrix corresponding to Uₑ: if the obtained difference value is less than a corresponding set difference threshold, it is determined that the stability of the force measurement system satisfies the stability requirements; otherwise, it is determined that the stability of the force measurement system does not satisfy the stability requirements.

Alternatively, a trace or a norm of the matrix UU^{T} is calculated, and a trace or a norm of U₂U₂^{T} is correspondingly subtracted from the trace or the norm of the matrix UU^{T}, to obtain a corresponding difference value. U₂ is an ideal deformation ratio matrix corresponding to U: if the obtained difference value is less than a corresponding set difference threshold, it is determined that the stability of the force measurement system satisfies the stability requirements; otherwise, it is determined that the stability of the force measurement system does not satisfy the stability requirements.

Further, the simulation model of the force measurement branches and the simulation model of the force measurement system are both finite element simulation models.

To solve the above technical problems, the disclosure further provides a computer apparatus including a processor executing a computer program to implement the steps of the structure optimization method of the force measurement system as described above.

To solve the above technical problems, the disclosure further provides a force measurement system adopting the force measurement system obtained through the structure optimization method of the force measurement system as described above.

The disclosure is an improved invention. In the structure optimization method of the force measurement system, computer apparatus, and force measurement system provided by the disclosure, considering an elastic resistance error is one of the main components of a coupling error, the structure parameters involved in the elastic resistance error are relatively comprehensive, the influences of axial stiffness and lateral deviation stiffness of force measurement on the structure performance, as well as the high correlation between the elastic resistance error and the design parameters of a force measurement system, the elastic resistance error is treated as an evaluation indicator for structure design in the disclosure, so as to improve the accuracy of structure design. Moreover, in the process of optimizing the structure of force measurement branches in the force measurement system, elastic resistance error coefficients that ignore deformation factors are adopted, so that the efficiency of subsequent structure design and optimization of the entire force measurement system may be improved. Based on the above, the non-force measurement structures other than the force measurement branches are optimized, and each part of the force measurement system is quantitatively designed, so that the efficiency and accuracy of the force measurement system design are improved. In addition, the disclosure is a general structure design method that combines the elastic resistance error and simulation, so that the advantages of theoretical methods in analyzing the relationship between structure performance and design parameters, as well as models in precise calculation of deformation and local loads are fully utilized.

### BRIEF DESCRIPTION OF THE DRAWINGS

FIG. 1 is a flow chart of a structure optimization method of a force measurement system in an embodiment of the structure optimization method of the force measurement system of the disclosure.

FIG. 2 is a structural view of the force measurement system in an embodiment of the structure optimization method of the force measurement system of the disclosure.

FIG. 3 is a schematic view of an influence of a moment on the system in an embodiment of the structure optimization method of the force measurement system of the disclosure.

FIG. 4 is a branch force deformation graph in an embodiment of the structure optimization method of the force measurement system of the disclosure.

FIG. 5 is a schematic diagram of force measurement branch layout in an embodiment of the structure optimization method of the force measurement system of the disclosure.

FIG. 6A, FIG. 6B, and FIG. 6C are schematic diagrams of different structural parameters of force measurement branches in an embodiment of the structure optimization method of the force measurement system of the disclosure.

Description of Reference Numerals: 1: force measurement system, 2: fixed frame, 3: moving frame, 4: load object, 5: force measurement branch, 6: x-direction moving frame support, and 7: x-direction fixed frame support.

### DESCRIPTION OF THE EMBODIMENTS

In the disclosure, considering an elastic resistance error is one of the main components of a coupling error, the structure parameters involved in the elastic resistance error are relatively comprehensive, the influences of axial stiffness and lateral deviation stiffness of force measurement on the structure performance, as well as the high correlation between the elastic resistance error and the design parameters of a force measurement system, the elastic resistance error is treated as an evaluation indicator for structure design in the disclosure, so as to improve the accuracy of structure design. Moreover, in the process of optimizing the structure of force measurement branches in the force measurement system, elastic resistance error coefficients that ignore deformation factors are adopted, so that the efficiency of subsequent structure design and optimization of the entire force measurement system may be improved. In addition, the disclosure is a general structure design method that combines the elastic resistance error and simulation, so that the advantages of theoretical methods in analyzing the relationship between structure performance and design parameters, as well as models in precise calculation of deformation and local loads are fully utilized. Further, in the disclosure, the design of main structure parameters of the force measurement system is divided into three parts in the entire scheme: structure parameter optimization of force measurement branches, structure parameter optimization of non-branch structures, and structure parameter fine-tuning of the entire force measurement system. Moreover, quantitative design is performed on each part. Therefore, the design efficiency and accuracy of the force measurement system are improved. In order to make the objectives, technical solutions, and advantages of the disclosure clearer and more comprehensible, the disclosure is further described in detail with reference to the drawings and embodiments.

### Embodiments of Structure Optimization Method of Force Measurement System

In the following, first, some main terms involved in this embodiment are explained.
1) Coupling error: Coupling error generally obtains the coupling error matrix through calibration experiments (also referred to as calibration). The diagonal elements of the coupling error matrix are referred to as Type I errors, and the non-diagonal elements are referred to as Type II errors, which are key indicators for evaluating the performance of force measurement systems.
2) Elastic resistance and interference: The coupling error matrix in experiments includes multiple factors such as the force measurement system structure, force measurement element characteristics, and environment. The disclosure aims to explore methods for force measurement system structure design through coupling errors, and therefore, focuses on coupling errors caused by factors such as structure stiffness and deformation. Based on the above, in the disclosure, the existing theoretical concepts of elastic resistance and interference are integrated, and the following definitions are made under this framework: In the coupling error matrix involving only structure factors, the diagonal elements that reflect the measurement accuracy of each single dimension are defined as “elastic resistance errors”, while those non-diagonal elements that reflect the degree of mutual influence between different dimensions are called “interference errors”.
3) Non-branch structure: All structures in the force measurement system except force measurement branches include moving frames, horizontal force measurement branch supports, etc.
4) Load-to-measurement ratio: Represents the ratio of the load applied in one direction to the load borne by the force measurement branch in that direction. Specifically, after an external force is applied to the force measurement system, the axial support reaction forces of all force measurement branches are extracted, and these support reaction forces are combined into force components in each direction. The load-to-measurement ratio is the ratio of the combined force component to the applied force component.

In this embodiment, the use of the elastic resistance errors as a structure forward design indicator is proposed, so as to ensure the accuracy of structure analysis and design. Moreover, a general structure design method applicable to force measurement systems is provided, and theoretical analytical expressions reflecting the relationship between the elastic resistance errors and the structure key parameters are established by using the ratio definition method. To enhance the efficiency of the structure forward design, in this embodiment, a general structure design method that combines the elastic resistance errors with finite element simulation (certainly, other simulation software with specific numerical simulation analysis capabilities may also be used) is adopted. In this method, the structure design parameters of the force measurement system are determined from both the structure stiffness and deformation aspects. As such, the advantages of theoretical methods in analyzing the relationship between structure performance and design parameters as well as finite element models in precise calculation of deformation and local loads are fully leveraged. In the following, detailed explanations of the content involved in this method are provided.

### I. Basic Information of Force Measurement System

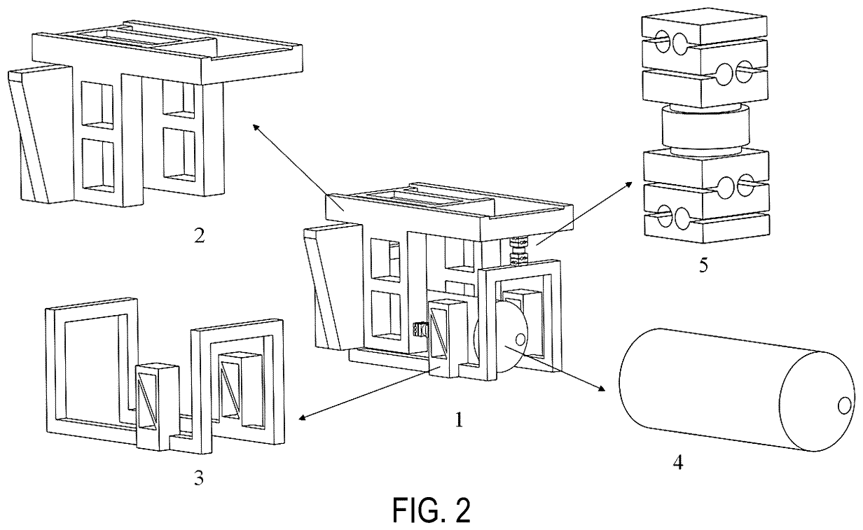

As shown in FIG. 2, a force measurement system 1 generally consists of a fixed frame 2, a moving frame 3, force measurement branches 5, and a supporting system. The core component of the force measurement system 1 is the force measurement branches 5. Each force measurement branch generally consists of one high-precision single-axis bidirectional tension-compression force measurement element and two two-axis flexible hinges, which are mainly used to achieve axial load measurement and non-axial load release. Before starting the force measurement system operation, a load object 4 under test (e.g., an engine) needs to be securely installed on the moving frame 2. Subsequently, known standard external force loads are applied to the engine to obtain calibration coefficients. During the force measurement process, the data collected by each force measurement branch 5 in the force measurement system is converted through pre-obtained calibration coefficients, so that the actual load state of the load object may be accurately mapped, and precise evaluation of an external load may thus be ensured.

### II. Description of Coupling of Force Measurement System

The force measurement system synthesizes the load under test through the axial forces of branches. To represent the relationship between the force measurement branches and the measurement components, when measuring a specific load component, the branches that need to directly synthesize this measurement component are defined as directly-related force measurement branches. Conversely, the branches that do not synthesize this measurement component are defined as indirectly-related force measurement branches. The mutual influence between the force measurement branches and the measurement components caused by structure deformation is referred to as system coupling, which consists of elastic resistance and interference. The elastic resistance refers to the load shared by the indirectly-related force measurement branches during the load measurement process of the directly-related measurement branches. Interference refers to the additional output generated by the indirectly-related force measurement branches due to loads.

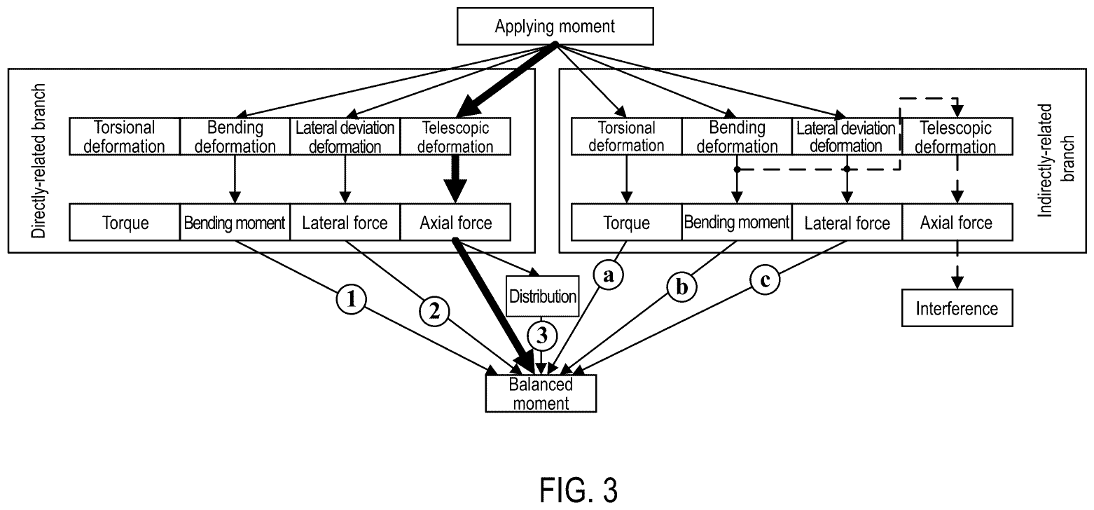

The influence of a force on the force measurement system is generally relatively simple, mainly manifested as axial deformation of the directly-related force measurement branches and lateral deviation deformation of the indirectly-related force measurement branches. However, the influence of moment on the system is more complex. The influence of moment on system branch deformation is shown in FIG. 3. The moment measurement process is represented by the thickest line in FIG. 3. This process involves converting the axial forces on the force measurement branches directly related to a target moment load component through appropriate coefficient relationships to restore the moment load. Moment measurement error is complex, with two main sources, shown respectively by the lines 1, 2, 3, a, b, and c in FIG. 3. Lines 1, 2, and 3 are error sources generated during the process of restoring applied moment loads by the directly-related force measurement branches (force measurement branches that directly generate axial forces): Line 1 represents the error caused by bending moments generated by end surface bending of the directly-related force measurement branches, Line 2 represents the error caused by moments generated on the system by lateral forces of the directly-related force measurement branches, and Line 3 represents the error caused by force arm deviation due to the distribution of axial forces on the end surfaces of the directly-related force measurement branches. Lines a, b, and c in FIG. 3 are three main factors causing moment elastic resistance errors: Line a represents the elastic resistance error caused by torsion of branches in the moment axial direction in the indirectly-related force measurement branches, Line b represents the elastic resistance error caused by bending moments generated by the indirectly-related force measurement branches, and Line c represents the elastic resistance error caused by lateral forces generated by the indirectly-related force measurement branches. The Dashed line in FIG. 3 represents axial force interference output caused by the deformation of the indirect measurement branches themselves.

For force and moment measurement, the synthesis error generated by the directly-related force measurement branches is mainly caused by their own non-axial deformation. While the indirectly-related force measurement branches mainly share the axial loading of the directly-related force measurement branches through lateral deviation deformation and bending deformation, and the shared load also generates interference on their own axial load output.

### III. Force Characteristics of Force Measurement Branches in Force Measurement System

Different from the measurement process, an equilibrium process needs to consider the complete force conditions of each force measurement branch. Each force measurement branch may be simplified as a beam model. Since the axial stiffness of each force measurement branch in the force measurement system is designed to be large, while the lateral deviation stiffness is two orders of magnitude less, the deformation of the force measurement branch is mainly characterized by end surface lateral deviation. When the end surface of a force measurement branch undergoes lateral deviation deformation, a force measurement element correspondingly generates a lateral reaction force and a bending moment. These two types of forces appear simultaneously and maintain a stable correlation, which is a unique characteristic in vector force measurement system applications. This characteristic cannot be considered when studying flexible hinges separately, while the disclosure considers this interaction effect at the complex force measurement system level.

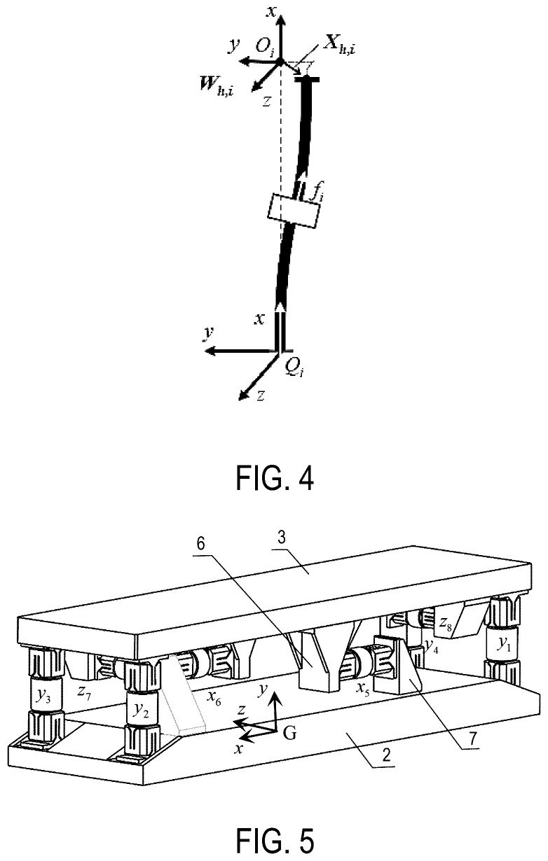

The main deformation configuration of a force measurement branch is shown in FIG. 4. In FIG. 4, Oᵢ is a contact point between an i^{th} force measurement branch and the moving frame, which is also a reference point of a load wrench. Qᵢ is a contact point between the i^{th} force measurement branch and the fixed frame, which is also a reference point of a local coordinate system of the force measurement branch. fᵢ is an axial force of the i^{th} force measurement branch and is generally equivalent to the measurement load of the force measurement branch. A deflection angle occurring at the end surface of the force measurement branch in the force measurement system is excessively small and may be ignored. A free end displacement vector of the i^{th} force measurement branch is defined as X_{h,i}, and the load wrench at its free end is W_{h,i}, and the relationship between the two may be established through a branch compliance matrix C_{h,i} to express:

$${X}_{h , i} = {C}_{h , i} {W}_{h , i} . \qquad ( 1 )$$

The above formula indicates that by setting the load wrench W_{h,i} as a unit matrix, the compliance matrix may be equivalent to the displacement matrix under the unit load. The load wrench W_{h,i} may be expressed as:

$${W}_{h , i} = [ \begin{matrix}{f}_{h , i} & {m}_{h , i}\end{matrix} ] = {[ \begin{matrix}{f}_{x , i} & {f}_{y , i} & {f}_{z , i} & {m}_{x , i} & {m}_{y , i} & {m}_{z , i}\end{matrix} ]}^{T} , \qquad ( 2 )$$

where f_{h,i} represents the force vector applied to the end surface of the i^{th} force measurement branch, m_{h,i} represents the moment vector applied to the end surface of the i^{th} force measurement branch, f_{x,i}, f_{y,i}, and f_{z,i} respectively represent the force components in the x, y, and z directions applied to the end surface of the i^{th} force measurement branch, m_{x,i}, m_{y,i}, and m_{z,i} respectively represent the moment components in the x, y, and z directions applied to the i^{th} force measurement branch.

The displacement vector X_{h,i} in formula (1) may be expressed as:

$${X}_{h , i} = {[ \begin{matrix}{u}_{h , i} & {θ}_{h , i}\end{matrix} ]}^{T} = {[ {u}_{x , i} , {u}_{y , i} , {u}_{z , i} , {θ}_{x , i} , {θ}_{y , i} , {θ}_{z , i} ]}^{T} , \qquad ( 3 )$$

where u_{h,i} represents the displacement deformation vector of the end surface of the i^{th} force measurement branch under an external force, Ohi represents the bending deformation vector of the end surface of the i^{th} force measurement branch under the external force, u_{x,i}, u_{y,i}, and u_{z,i} respectively represent the displacement components in the x, y, and z directions of the end surface of the i^{th} force measurement branch under the external force, θ_{x,i}, θ_{y,i}, and θ_{z,i} respectively represent the bending deformation components in the x, y, and z directions of the end surface of the i^{th} force measurement branch under the external force.

Assuming that the deformation of the force measurement branch is within an elastic limit range of a linear elastic material, the branch compliance matrix C_{h,i} in formula (1) may be derived from the beam element strain energy formula as follows:

$${C}_{h , i} = [ \begin{matrix}{C}_{hi , 11} & 0 & 0 & 0 & 0 & 0 \\ 0 & {C}_{hi , 22} & 0 & 0 & 0 & {C}_{hi , 26} \\ 0 & 0 & {C}_{hi , 33} & 0 & {C}_{hi , 35} & 0 \\ 0 & 0 & 0 & {C}_{hi , 44} & 0 & 0 \\ 0 & 0 & {C}_{hi , 53} & 0 & {C}_{hi , 55} & 0 \\ 0 & {C}_{hi , 62} & 0 & 0 & 0 & {C}_{hi , 66}\end{matrix} ] . \qquad ( 4 )$$

The elements in the matrix C_{h,i} are all compliance elements. Many researchers construct the mathematical model of the branch compliance matrix C_{h,i} according to Castigliano's second theorem and verify it using finite element method. Their research shows high consistency between the obtained mathematical model and the finite element model. In order to more effectively satisfy the analysis requirements of the complex situations of the force measurement branches, the disclosure directly extracts through the finite element simulation technology according to formula (5) to extract the C_{h,i} compliance elements, so that the adaptability and accuracy of the analysis are improved.

$${C}_{h , i} = [ \begin{matrix}{u}_{x , i} / {f}_{x , i} & 0 & 0 & 0 & 0 & 0 \\ 0 & {u}_{y , i} / {f}_{y , i} & 0 & 0 & 0 & {u}_{y , i} / {m}_{z , i} \\ 0 & 0 & {u}_{z , i} / {f}_{z , i} & 0 & {u}_{z , i} / {m}_{y , i} & 0 \\ 0 & 0 & 0 & {θ}_{x , i} / {m}_{x , i} & 0 & 0 \\ 0 & 0 & {θ}_{y , i} / {f}_{z , i} & 0 & {θ}_{y , i} / {m}_{y , i} & 0 \\ 0 & {θ}_{z , i} / {f}_{y , i} & 0 & 0 & 0 & {θ}_{z , i} / {m}_{z , i}\end{matrix} ] \qquad ( 5 )$$

The stiffness matrix of the branch

$${K}_{h , i} = {C}_{h , i}^{- 1} ,$$

the serial mechanisms satisfy compliance additivity, and parallel mechanisms satisfy stiffness additivity. Therefore, compliance is suitable for modeling and analysis of the force measurement branches, and stiffness is suitable for modeling and analysis of the parallel mechanisms. The stiffness matrix K_{h,i} under the local coordinate system may be expressed as:

$${K}_{h , i} = [ \begin{matrix}{K}_{fx , ui} & 0 & 0 & 0 & 0 & 0 \\ 0 & {K}_{fy , ui} & 0 & 0 & 0 & {K}_{fz , θ i} \\ 0 & 0 & {K}_{fz , ui} & 0 & {K}_{fy , θ i} & 0 \\ 0 & 0 & 0 & {K}_{mx , θ i} & 0 & 0 \\ 0 & 0 & {K}_{mz , θ i} & 0 & {K}_{my , θ i} & 0 \\ 0 & {K}_{my , θ i} & 0 & 0 & 0 & {K}_{mz , θ i}\end{matrix} ] . \qquad ( 6 )$$

The elements in the stiffness matrix K_{h,i} are all stiffness elements.

There are currently two ways to define the compliance ratio. Approach 1: A compliance matrix is established based on the second Cartesian theorem, and the corresponding compliance ratio is established according to the analysis requirements through the compliance matrix elements. For instance, in order to analyze the relationship between displacement compliance and rotational compliance, the compliance ratio is defined as the ratio of displacement compliance to rotational compliance. Approach 2: The force measurement branch is treated as a small deformation beam model, the ratio of load to deflection is calculated to obtain the compliance in all directions, and the ratio of lateral compliance ratio to axial compliance is defined as the compliance ratio. The starting points of the two definitions of compliance ratio are different. Approach 1 starts from the energy method, which has more extensive analysis and research. Approach 2 starts from a simplified beam of equal cross-section, which is more convenient for engineering calculations. The two are equivalent in practical applications, and the specific process is as follows.

The deformation of the end surface of the force measurement branch in the force measurement system usually shows the force characteristics of the branch as shown in FIG. 4. It can be concluded that the overall rotational displacement of the flexible hinge is close to zero. If it is assumed that the free end rotation angle of the force measurement branch is zero, it can be obtained:

$$\{ \begin{matrix}{θ}_{y , i} = {C}_{h i , 53} {f}_{z , i} + {C}_{h i , 55} {m}_{y , i} = 0 \\ {θ}_{z , i} = {C}_{h i , 62} {f}_{y , i} + {C}_{h i , 66} {m}_{z , i} = 0\end{matrix} . \qquad ( 7 )$$

The compliance ratio γ of the branch lateral compliance to the axial compliance in the force measurement system can be obtained through the expression as follows:

$$\{ \begin{matrix}{γ}_{y , i} = \frac{{C}_{hi , 22} - {C}_{hi , 26} \cdot {C}_{hi , 62} / {C}_{hi , 66}}{{C}_{hi , 11}} = \frac{1}{{K}_{Qy , i}} \\ {γ}_{z , i} = \frac{{C}_{hi , 33} - {C}_{hi , 35} \cdot {C}_{hi , 53} / {C}_{hi , 55}}{{C}_{hi , 11}} = \frac{1}{{K}_{Qz , i}}\end{matrix} , \qquad ( 8 )$$

where γ_{y,i} is the compliance of the i-direction force measurement branch in the y direction under the condition of restricted rotational degrees of freedom, and γ_{z,i} is the compliance of the i-direction force measurement branch in the z direction under the condition of restricted rotational degrees of freedom. The stiffness of the i-direction force measurement branch in the y direction under the condition of restricted rotational degrees of freedom may be defined as K_{Qy,i}, and the stiffness of the i-direction force measurement branch in the z direction is K_{Qz,i}.

In formula (8), the two definition approaches of compliance ratios in the force measurement system are effectively integrated and unified. Therefore, the acquisition of compliance ratios of force measurement branches in the force measurement system may be obtained through the compliance matrix, or may be directly obtained by constraining the rotational degrees of freedom of the free end of the force measurement branch and extracting the lateral displacement and lateral load of the force measurement branch.

### IV. Load Balance and Elastic Resistance of Measurement System

For the force measurement system, the essence of elastic resistance is that indirectly related force measurement branches generate resistance in the direction of the measurement branch, so that the load of the branch measured in the measurement direction is reduced. Generally, the force measurement branch is simplified as a beam model. For the beam model, the essence of interference is that forces in non-measurement directions cause changes in the axial length of the measurement direction branch, so that additional axial forces are generated. Therefore, the relationship among the true value (external load), measurement component, elastic resistance, and interference may be expressed as: measurement component true value=output component (synthesis of axial forces of force measurement branches)+elastic resistance−interference.

The measurement model formula is expressed as:

$${W}_{P} = {W}_{s} + {EW}_{s} = {W}_{s} + ( T - D ) {W}_{s} , \qquad ( 9 )$$

where, Wp is the load wrench,

$${W}_{p} = {\sum }_{i = 1}^{n} {W}_{G , i} = [ \begin{matrix}{P}_{Fx} & {P}_{Fy} & {P}_{Fz} & {P}_{Mx} & {P}_{My} & {P}_{Mz}\end{matrix} ] ,$$

where P_{Fx}, P_{Fy}, and P_{Fz} are the force components of the external load borne by the force measurement system in three orthogonal directions, P_{Mx}, P_{My}, and P_{Mz} are the moment components of the external load borne by the force measurement system in three orthogonal directions, Wₛ is the measurement force wrench, synthesized by the axial loads of the force measurement branches, Wₛ=[Fₓ F_{y} F_{z} Mₓ M_{y} M_{z}], where Fₓ, F_{y}, and F_{z} represent the force components of the load synthesized by the reaction forces of the force measurement branches in three orthogonal directions, Mₓ, M_{y}, and M_{z} represent the moment components of the load synthesized by the reaction forces of the force measurement branches in three orthogonal directions. E is the coupling error coefficient matrix, T is the elastic resistance error coefficient matrix, and D is the interference error coefficient matrix. Herein, the elastic resistance error coefficient matrix T and the interference error coefficient matrix D are respectively expressed in matrix forms as:

$$T = [ \begin{matrix}{T}_{f , x} & \\ & \\ & \\ & \\ & \\ \\ \\ & {T}_{f , y} & \\ & \\ & \\ & \\ \\ \\ & \\ & {T}_{f , z} & \\ & \\ & \\ \\ \\ & \\ & \\ & {T}_{m , x} & \\ & \\ \\ \\ & \\ & \\ & \\ & {T}_{m , y} & \\ \\ \\ & \\ & \\ & \\ & \\ & {T}_{m , z}\end{matrix} ] and \qquad ( 10 )$$

$$D = [ \begin{matrix}0 & {D}_{fx , fy} & {D}_{fx , fz} & {D}_{fx , mx} & {D}_{fx , my} & {D}_{fx , mz} \\ {D}_{fy , fx} & 0 & {D}_{fy , fz} & {D}_{fy , mx} & {D}_{fy , my} & {D}_{fy , mz} \\ {D}_{fz , fx} & {D}_{fz , fy} & 0 & {D}_{fz , mx} & {D}_{fz , my} & {D}_{fz , mz} \\ {D}_{mx , fx} & {D}_{mx , fy} & {D}_{mx , fz} & 0 & {D}_{mx , my} & {D}_{mx , mz} \\ {D}_{my , fx} & {D}_{my , fy} & {D}_{my , fz} & {D}_{my , mx} & 0 & {D}_{my , mz} \\ {D}_{mz , fx} & {D}_{mz , fy} & {D}_{mz , fz} & {D}_{mz , mx} & {D}_{mz , my} & 0\end{matrix} ] , \qquad ( 11 )$$

where T_{f,i} (i∈{x y z}) is the force elastic resistance coefficient in the i direction, T_{m,i}(i∈{x y z}) is the moment elastic resistance coefficient surrounding the i axis, D_{fi,fj}(i, j∈{x y z},i≠j) represents the interference coefficient of the force in the i direction on the force measurement in the j direction, D_{fi,mj}(i, j∈{x y z},i≠j) represents the interference coefficient of force in the i direction on the moment measurement surrounding the j axis, D_{mi,fj}(i, j∈{x y z},i≠j) represents the interference coefficient of the force surrounding the i axis on the force measurement in the j direction, and D_{mi,mj}(i, j∈{x y z},i≠j) represents the interference coefficient of the force surrounding the i axis on the moment measurement surrounding the j axis. When no interference exists, D is a zero matrix and may be transformed to:

$$\frac{{W}_{P}}{{W}_{s}} = I + T , \qquad ( 12 )$$

where I is a column vector with all elements equal to 1. The above formula indicates that: without considering the interference error, description of the content of the load-to-measurement ratio of each load component and description of the content of the elastic resistance are the same, namely: “load-to-measurement ratio=elastic resistance error coefficient+1”. It should be noted that the elastic resistance error coefficient herein is the elastic resistance error coefficient considering the deformation factors.

### V. Elastic Resistance Error Coefficient of Force

Through simulating the effectiveness verification of the coupling analysis model, it can be known that the elastic resistance error in the coupling error has significant correlation with key design parameters such as structural stiffness and deformation. Therefore, the elastic resistance error may be treated as a performance indicator for structural design, and the elastic resistance error coefficient expression may be treated as a theoretical model for structural analysis and design of force measurement systems. This theoretical model achieves forward design of force measurement branch structural parameters according to the expected performance of the force measurement system by correlating the elastic resistance error with several key parameters of the force measurement branches-branch number, axial stiffness, lateral deviation stiffness, and end surface deformation.

The elastic resistance error coefficient is the ratio of the applied load component to the measured load component for a specific component. Taking the x-direction force load component as an example, the force elastic resistance model is established:

$$\frac{{P}_{Fx}}{{F}_{x}} = 1 + {T}_{f , x} = 1 + \frac{\sum {f}_{x , y}}{\sum {f}_{x , x}} + \frac{\sum {f}_{x , z}}{\sum {f}_{x , x}} = 1 + {T}_{fx , yx} + {T}_{fx , zx} , \qquad ( 13 )$$

where f_{x,x} is the force generated by the x-direction force measurement branch in the x direction, which is an axial force, f_{x,y} is the force generated by the y-direction force measurement branch in the x direction, which is the lateral force (shear force) of the y-direction force measurement branch, f_{x,z} is the force generated by the z-direction force measurement branch in the x direction, which is the lateral force (shear force) of the z-direction force measurement branch, and the coefficient T_{fx,yx} represents the elastic resistance error coefficient related to the elastic resistance error of the y-direction force measurement branch on x-direction force measurement, which may be expressed as:

$${T}_{fx , yx} = \frac{\sum {f}_{x , y}}{\sum {f}_{x , x}} = \frac{{n}_{y}}{{n}_{x}} ( \frac{{K}_{fx , uy}}{{K}_{fx , ux}} \frac{{\overline{u}}_{Gx , y}}{{\overline{u}}_{Gx , x}} + \frac{{K}_{fz , θ y}}{{K}_{fx , ux}} \frac{{\overline{θ}}_{Gz , y}}{{\overline{u}}_{Gx , x}} ) , \qquad ( 14 )$$

where n_{y} represents the number of y-direction force measurement branches, and nₓ represents the number of x-direction force measurement branches. The four subscripts in K_{fx,ux} represent four pieces of information about the stiffness, where the first subscript f represents force component related, the second subscript x indicates branch deformation in the global coordinate system x-direction, the third subscript u represents displacement related, and the fourth subscript x represents the x-direction force measurement branch, so K_{fx,ux} represents the displacement stiffness in the x direction caused by the force component in the x direction of the x-direction force measurement branch in the global coordinate system; similarly K_{fx,uy} represents the displacement stiffness in the x direction caused by the force component in the x direction of the y-direction force measurement branch in the global coordinate system, K_{fx,θy} represents the bending stiffness toward the x direction caused by the force component in the x direction of the y-direction force measurement branch in the global coordinate system, ū_{Gx,y} represents the average value of displacement in the x direction of the y-direction force measurement branch in the global coordinate system, ū_{Gx,x} represents the average value of displacement in the x direction of the x-direction force measurement branch in the global coordinate system, and θ̅_{Gx,y} represents the average value of bending in the x direction of the y-direction force measurement branch in the global coordinate system.

For the convenience of structural description, structures other than the force measurement branches, such as the moving platform and supports, are uniformly defined as the non-branch structures. The coupling error is associated with the main design parameters of the structure. Therefore, theoretically, the key parameters of the force measurement system may be designed through the coupling error. To make structural design more convenient, the elastic resistance model is further improved. To be specific, the axial stiffness K_{fy,uy}/K_{fy,uy} of the interference branch is introduced into the force elastic resistance model shown in formula (14), and the following may be obtained:

$${T}_{fx , yx} = \frac{{n}_{y}}{{n}_{x}} \frac{{K}_{fy , uy}}{{K}_{fx , ux}} ( \frac{{K}_{fx , uy}}{{K}_{fy , uy}} \frac{{\overline{u}}_{Gx , y}}{{\overline{u}}_{Gx , x}} + \frac{{K}_{fz , θ y}}{{K}_{fy , uy}} \frac{{\overline{θ}}_{Gz , y}}{{\overline{u}}_{Gx , x}} ) . \qquad ( 15 )$$

Therefore, the elastic resistance error coefficient for any component in the force components may be expressed as:

$${T}_{fi , ji} = \frac{{n}_{j}}{{n}_{i}} \frac{{K}_{fj , uj}}{{K}_{fi , ui}} ( \frac{{K}_{fi , uj}}{{K}_{fj , uj}} \frac{{\overline{u}}_{Gi , j}}{{\overline{u}}_{Gi , i}} + \frac{{K}_{fk , θ j}}{{K}_{fj , uj}} \frac{{\overline{θ}}_{Gk , j}}{{\overline{u}}_{Gi , i}} ) ( i , j , k ∈ \{ \begin{matrix}x & y & z\end{matrix} \} , i \neq j \neq k ) , \qquad ( 16 )$$

where, nᵢ represents the number of force measurement branches in the i direction, nⱼ represents the number of force measurement branches in the j direction, K_{fi,ui} represents the displacement stiffness in the i direction caused by the force component in the i direction of the i-direction force measurement branch in the global coordinate system, K_{fj,uj} represents the displacement stiffness in the j direction caused by the force component in the j direction of the j-direction force measurement branch in the global coordinate system, K_{fi,uj} represents the displacement stiffness in the i direction caused by the force component in the i direction of the j-direction force measurement branch in the global coordinate system, K_{fk,θj} represents the bending stiffness surrounding the k direction caused by the moment component surrounding the k direction of the j-direction force measurement branch in the global coordinate system, ū_{Gi,i} represents the average value of displacement in the i direction of the i-direction force measurement branch in the global coordinate system, ū_{Gi,j} represents the average value of displacement in the i direction of the j-direction force measurement branch in the global coordinate system, and θ̅_{Gk,j} represents the average value of bending in the direction of the j-direction force measurement branch in the global coordinate system.

The force elastic resistance error coefficient shown in formula (16) mainly includes four types of ratios, ratio 1: the ratio of branch numbers between components nⱼ/nᵢ, ratio 2: the ratio of branch axial stiffness between components K_{fj,uj}/K_{fi,ui}, ratio 3: the ratio of lateral deformation stiffness (i.e., lateral deviation stiffness) to axial stiffness for each branch K_{fi,uj}/K_{fj,uj} and the ratio of branch bending stiffness to axial stiffness K_{fk,θj}/K_{fj,uj}, and ratio 4: the ratio of deformation in the same direction between components u_{Gi,j}/u_{Gi,i} and θ_{Gk,j}/u_{Gi,i}. Among the four ratios of the elastic resistance error coefficient, ratio 1 may be determined according to layout requirements or stability needs, ratio 2 is determined according to the branch load calculation model, ratio 3 is a key design variable, is the key parameter reflecting the “rigid” and “flexible” configuration of force measurement branches in the force measurement system, and needs to be designed by comprehensively considering all aspects of flexible hinge requirements, and ratio 4 is the ratio of deformation under the assumption of material linear elasticity and is the comprehensive effect of the overall structural form, non-branch structural stiffness, and branch stiffness acting together.

Moreover, without considering the deformation ratio parameters in formula (16), i.e., setting the displacement deformation ratio to 1 and the angular displacement deformation ratio to 0 in formula (16), i.e.,

$$\frac{{\overline{u}}_{Gi , j}}{{\overline{u}}_{Gi , i}} = 1 and \frac{{\overline{θ}}_{Gk , j}}{{\overline{u}}_{Gi , i}} = 0 ,$$

under this condition, formula (16) is transformed into:

$${T}_{fi , ji} = \frac{{n}_{j}}{{n}_{i}} \frac{{K}_{fj , uj}}{{K}_{fi , ui}} \frac{{K}_{fi , uj}}{{K}_{fj , uj}} ( i , j , k ∈ \{ \begin{matrix}x & y & z\end{matrix} \} , i \neq j \neq k ) , \qquad ( 17 )$$

where T_{fi,ji} in formula (17) represents the elastic resistance error coefficient of the j-direction force measurement branch on the i-direction force measurement, ignoring deformation factors, and T_{fi,ji} in formula (16) represents the elastic resistance error coefficient of the j-direction force measurement branch on the i-direction force measurement, considering deformation factors.

In addition, it is also necessary to use the finite element model to design the stiffness of non-branch structures and branch layout. In finite element analysis, the stress, deformation, and local load of the force measurement system structure can be accurately calculated. The elastic resistance error of the finite element model of the force measurement system is the effect of the combined action of the force measurement branch structure, force measurement branch layout, and non-branch structure, while the elastic resistance error coefficient only reflects the elastic resistance error caused by force measurement branches. Therefore, the difference value between the two may reflect the performance of the non-branch structures and the force measurement branch layout.

### VI. Stiffness Design of Non-Branch Structure

Single component loads are applied to the force measurement system in three orthogonal directions, and the ratio of the load in each direction to the force component synthesized by the force measurement branch is defined as a load-to-measurement ratio. When single component loading is applied, there is no interference error, and at this time “elastic resistance error coefficient T=load-to-measurement ratio η_{f}−1” is satisfied. The axial support reaction forces of each force measurement branch are extracted through the finite element model, the load components borne by the system is thus synthesized, and the load-to-measurement ratio is further obtained. Therefore, the concept of load-to-measurement ratio is more intuitive and convenient for data processing. Therefore, the elastic resistance error coefficient may be calculated through the load-to-measurement ratio.

Without considering the deformation ratio parameter in the elastic resistance error coefficient formula, that is, setting the displacement deformation ratio to 1, that is,

$$\frac{{\overline{u}}_{Gi , j}}{{\overline{u}}_{Gi , i}} = 1$$

in formula (16) and the angular displacement deformation ratio to 0. That is,

$$\frac{{\overline{θ}}_{Gk , j}}{{\overline{u}}_{Gi , i}} = 0$$

in formula (16). The branch number ratio and stiffness ratio are calculated through the finite element model, so that the force component elastic resistance error coefficient vector without deformation ratio T_{fw} can be calculated. The difference between the force component elastic resistance error coefficient vector T_{f} and the elastic resistance error coefficient vector without deformation ratio T_{fw} may be used to evaluate the stiffness of the non-branch structure, and this difference value is defined as the non-branch structure evaluation coefficient vector ηₜ:

$${η}_{t} = {T}_{f} - {T}_{fw} = {η}_{f} - 1 - {T}_{fw} , \qquad ( 18 )$$

where ηₜ=[η_{t,x} η_{t,y} η_{t,z}]^{T}, η_{t,x}, η_{t,y}, and η_{t,z} are the non-branch structure evaluation coefficients in three orthogonal directions, T_{f}=[T_{f,x} T_{f,y} T_{f,z}]^{T}, T_{f,x}, T_{f,y}, and T_{f,z} are the force component elastic resistance error coefficients in three orthogonal directions, T_{fw}=[T_{fw,x} T_{fw,y} T_{fw,z}]^{T}, T_{fw,x}, T_{fw,y}, and T_{fw,z} are the force component elastic resistance error coefficients without deformation ratio in three orthogonal directions, η_{f}=[ηf,x η_{f,y} ηf,z]^{T}, η_{f,x}, η_{f,y}, and η_{f,z} are the force component load-to-measurement ratios in three orthogonal directions.

The measurement deviation caused by non-force measurement branches due to factors such as deformation of support members of the structure may be evaluated by ηₜ. In the design of large load force measurement systems, designers may lack reasonable understanding of structural stiffness, and the stiffness effect of non-branch structures may be evaluated by ηₜ, so that the stiffness of non-branch structures such as moving frames and supports may thus be easily designed.

### VII. Deformation Ratio Stability and Layout Design.

Stability in structural equipment not only involves the ability of the structure to maintain its structural and functional stability under various conditions, but also includes the performance of the structure under conditions such as bearing loads, dynamic loads, and thermal changes. It mainly involves several aspects, including structural stability, elastic stability, dynamic stability, thermal stability, etc. For a force measurement system, stability may mainly be reflected through deformation. Therefore, the deformation ratio may reflect the coordination of force measurement branch deformation and the stability of the overall system, and thus, the deformation ratio matrix under single component loading may be used for stability assessment of the force measurement system.

For a force measurement system, whether in the design stage or the later experimental stage, the two types of information that are relatively easy to obtain are the axial forces of the branches and the deformation displacements of the branch end surfaces. Therefore, elastic resistance and deformation ratio are two relatively good entry points for structural design and performance analysis. The material itself may have non-uniformity, processing and assembly may produce geometric and positional errors, and connection stiffness nonlinearity may occur at component connection cross-sections, etc. Many errors are reflected in stiffness and ultimately manifested in the form of deformation displacement. The magnitude of deformation displacement has a strong correlation with the generation of many nonlinear errors.

Therefore, for general orthogonal compliant force measurement systems and similar mechanisms, conducting stability design from the perspective of deformation is a feasible approach. The deformation ratio from the elastic resistance error coefficient in the above formula (16) is extracted to obtain the deformation ratio matrix U is:

$$U = [ \begin{matrix}{\overline{u}}_{Gy , x} / {\overline{u}}_{Gx , x} & {\overline{θ}}_{Gy , x} / {\overline{u}}_{Gx , x} & {\overline{u}}_{Gz , x} / {\overline{u}}_{Gx , x} & {\overline{θ}}_{Gz , x} / {\overline{u}}_{Gx , x} \\ {\overline{u}}_{Gx , y} / {\overline{u}}_{Gy , y} & {\overline{θ}}_{Gx , y} / {\overline{u}}_{Gy , y} & {\overline{u}}_{Gz , y} / {\overline{u}}_{Gy , y} & {\overline{θ}}_{Gz , y} / {\overline{u}}_{Gy , y} \\ {\overline{u}}_{Gx , z} / {\overline{u}}_{Gz , z} & {\overline{θ}}_{Gx , z} / {\overline{u}}_{Gz , z} & {\overline{u}}_{Gy , z} / {\overline{u}}_{Gz , z} & {\overline{θ}}_{Gy , z} / {\overline{u}}_{Gz , z}\end{matrix} ] , \qquad ( 19 )$$

where ū_{Gy,x} represents the average value of the y-direction displacement of the x-direction force measurement branch in the global coordinate system, ū_{Gx,x} represents the average value of the x-direction displacement of the x-direction force measurement branch in the global coordinate system, ū_{Gx,y} represents the average value of the x-direction displacement of the y-direction force measurement branch in the global coordinate system, ū_{Gy,y} represents the average value of the y-direction displacement of the y-direction force measurement branch in the global coordinate system, ū_{Gx,z} represents the average value of the x-direction displacement of the z-direction force measurement branch in the global coordinate system, ū_{Gz,z} represents the average value of the z-direction displacement of the z-direction force measurement branch in the global coordinate system, θ̅_{Gy,x} represents the average value of the x-direction force measurement branch bending surrounding the y direction in the global coordinate system, θ̅_{Gx,y} represents the average value of the of the y-direction force measurement branch bending surrounding the x direction in the global coordinate system, θ̅_{Gx,z} represents the average value of the z-direction force measurement branch bending surrounding the x direction in the global coordinate system, ū_{Gz,x} represents the average value of the z-direction displacement of the x-direction force measurement branch in the global coordinate system, ū_{Gz,y} represents the average value of the z-direction displacement of the y-direction force measurement branch in the global coordinate system, ūGy,z represents the average value of the y-direction displacement of the z-direction force measurement branch in the global coordinate system, θ̅_{Gz,x} represents the average value of the x-direction force measurement branch bending surrounding a z direction in the global coordinate system, θ̅_{Gz,y} represents the average value of the y-direction force measurement branch bending in the z direction in the global coordinate system, and θ̅_{Gy,z} represents the average value of the z-direction force measurement branch bending surrounding the y direction in the global coordinate system. In formula (10), the closer the elements in a first column and a third column are to 1, and the closer the elements in a second column and a fourth column are to 0, the better the stability of the entire force measurement system.

For the elastic resistance design model of the force measurement system, the angle of the force measurement branch is almost 0, so the deformation ratio matrix shown in formula (19) may be simplified as:

$${U}_{e} = [ \begin{matrix}{\overline{u}}_{Gx , x} / {\overline{u}}_{Gx , x} & {\overline{u}}_{Gx , y} / {\overline{u}}_{Gx , x} & {\overline{u}}_{Gx , z} / {\overline{u}}_{Gx , x} \\ {\overline{u}}_{Gy , x} / {\overline{u}}_{Gy , y} & {\overline{u}}_{Gy , y} / {\overline{u}}_{Gy , y} & {\overline{u}}_{Gy , z} / {\overline{u}}_{Gy , y} \\ {\overline{u}}_{Gz , x} / {\overline{u}}_{Gz , z} & {\overline{u}}_{Gz , y} / {\overline{u}}_{Gz , z} & {\overline{u}}_{Gz , z} / {\overline{u}}_{Gz , z}\end{matrix} ] . \qquad ( 20 )$$

Through Uₑ, the branch number and branch stiffness performance may be ignored, and only the deformation stability (i.e., the stability of the force measurement system claimed in this embodiment) is analyzed, so that the structural deformation stability may be improved. The closer each element in formula (20) is to 1, the better the stability of the entire force measurement system.

Specifically, where different branch layout effects may be achieved through a trace or a norm of the matrix Uₑ and the corresponding trace or norm of the ideal deformation ratio matrix U₁ for comparative evaluation, or may be evaluated through the trace or norm of the matrix UU^{T} and the trace or norm of the matrix U₂U₂^{T} for comparative evaluation. U₂ is the ideal deformation ratio matrix corresponding to U. The ideal deformation ratio matrix corresponding to Uₑ is

$${U}_{1} = [ \begin{matrix}1 & 1 & 1 \\ 1 & 1 & 1 \\ 1 & 1 & 1\end{matrix} ] ,$$

and the ideal deformation ratio matrix corresponding to

$$U is {U}_{2} = [ \begin{matrix}1 & 0 & 1 & 0 \\ 1 & 0 & 1 & 0 \\ 1 & 0 & 1 & 0\end{matrix} ] .$$

Taking the matrix U as an example, the ideal deformation ratio matrix corresponding to U is

$${U}_{2} = [ \begin{matrix}1 & 0 & 1 & 0 \\ 1 & 0 & 1 & 0 \\ 1 & 0 & 1 & 0\end{matrix} ] ,$$

the trace of the matrix U₂U₂^{T} is 6, and the L2 norm is also 6. If the actual deformation ratio matrix is

$$U = [ \begin{matrix}1.21 & 0.12 & 1.11 & 0.13 \\ 1.18 & 0.08 & 1.32 & 0.09 \\ 1.12 & 0.14 & 1.18 & 0.31\end{matrix} ] ,$$

the trace of the matrix UU^{T} is 8.5922 and the L2 norm is 8.6393. If the parameters of the first row and first column of the optimization matrix are optimized from 1.21 to 1.11, the actual deformation ratio matrix

$$U = [ \begin{matrix}1.11 & 0.12 & 1.11 & 0.13 \\ 1.18 & 0.08 & 1.32 & 0.09 \\ 1.12 & 0.14 & 1.18 & 0.31\end{matrix} ]$$

is obtained. At this time, the trace of the matrix UU^{T} is 8.3709 and the L2 norm is 8.4073. This indicates that the trace and norm of the matrix may reflect the optimization effect. When multiple deformation ratio parameters are optimized, the trace and norm of the matrix may reflect the degree of optimization. Meanwhile, from a mathematical perspective, the norm of a matrix is used to evaluate the size of the matrix. When the matrix is large, it represents a large deformation ratio, resulting in relatively poor stability (deformation→matrix size→stability). The trace of a matrix is the sum of eigenvalues. In matrix transformation, the eigenvalues of a matrix may be regarded as the magnification factor in a specific dimension. Therefore, the trace of the matrix may also be used to measure the size of the matrix.

Therefore, when making corresponding comparisons, the specific means may be any one of the following. If the difference value between the trace of Uₑ and the trace of U₁ is small, for example, the difference value is less than a specific threshold, then it is determined that the stability of the force measurement system satisfies the stability requirements. If the difference value between the Uₑ norm and the U₁ norm is small, for example, the difference value is less than a specific threshold, then the stability of the force measurement system is determined to satisfy the stability requirements. If the difference value between the trace of UU^{T} and the trace of U₂U₂^{T} is small, for example, the difference value is less than a specific threshold, then it is determined that the stability of the force measurement system satisfies the stability requirements. If the difference value between the UU^{T} norm and the U₂U₂^{T} norm is small, for example, the difference value is less than a specific threshold, then the stability of the force measurement system is determined to satisfy the stability requirements.

### VIII. Method Flow

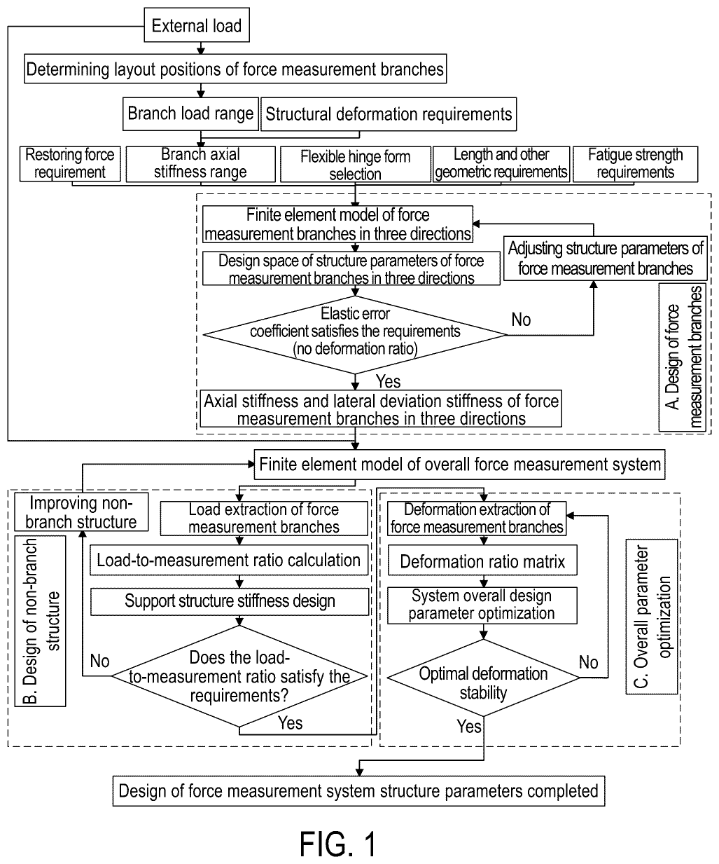

Based on the theoretical knowledge introduced above, the method flow shown in FIG. 1 may be adopted to perform structure optimization of the force measurement system. The specific steps are as follows:
1) The characteristics and indicator requirements of the force measurement system are determined, and the preliminary layout scheme of the force measurement branches in the force measurement system is designed. The layout scheme specifically includes information such as the number of force measurement branches included in the force measurement system, the direction of the force measurement branches, the preliminary arrangement positions of the force measurement branches, the form of flexible hinges in the force measurement branches, etc.
2) According to the external load applied in the force measurement system, the load range of each force measurement branch, i.e., the axial load of each force measurement branch is determined. Next, according to the structural deformation requirements of all force measurement branches (for example, specifically the axial deformation requirements of the force measurement branches), the axial stiffness range of the force measurement branches in each direction (specifically the minimum axial stiffness of the force measurement branches in each direction) is determined.
3) According to the parameters of step 1) and step 2), finite element models of force measurement branches in three directions are constructed, and combined with the selected form of flexible hinges in the force measurement branches, the stiffness range of flexible hinges of the force measurement branches, fatigue strength, restoring force requirements, as well as the structure parameter requirements of the force measurement branches (for example, geometric dimension requirements such as the length of the force measurement branches in each direction), simulation experiments are performed. During the simulation experiment process through the finite element models, with the goal that the elastic resistance error coefficients ignoring deformation factors in each direction (referred to as force measurement branch indicators) are all smaller, iterative calculation of multiple adjustments is performed to the structure parameters of the force measurement branches until convergence, so as to design the stiffness of the force measurement branches (including axial stiffness and lateral deviation stiffness) to obtain the latest force measurement branch structure.

Here, the elastic resistance error coefficient ignoring the deformation factor in a specific direction is the sum of elastic resistance errors generated by the force measurement branches in the other two directions on the force measurement in that specific direction. For instance, the elastic resistance error coefficient ignoring the deformation factor in the x direction is the sum of the elastic resistance error coefficients ignoring the deformation factors generated by the y- and z-direction force measurement branches respectively on the x-direction force measurement. Moreover, the elastic resistance error coefficient generated by the y-direction force measurement branch on the x-direction force measurement is a product of the number ratio of the y-direction force measurement branches to the x-direction force measurement branches, the axial stiffness ratio of the y-direction force measurement branch to the x-direction force measurement branch, and the ratio of the lateral deviation stiffness of the y-direction force measurement branch to the axial stiffness of the y-direction force measurement branch. By analogy, the elastic resistance error coefficients in other directions can be derived. The calculation formula for the elastic resistance error coefficients ignoring the deformation factors generated by the y- and z-direction force measurement branches on the x-direction force measurement may refer to formula (17), thus the final calculation formula for the elastic resistance error coefficient ignoring the deformation factor in each direction is:

$$\{ \begin{matrix}\begin{matrix}{T}_{fw , x} = {T}_{fx , yx} + {T}_{fx , zx} = \frac{{n}_{y}}{{n}_{x}} \frac{{K}_{fy , uy}}{{K}_{fx , ux}} \frac{{K}_{fx , uy}}{{K}_{fy , uy}} + \frac{{n}_{z}}{{n}_{x}} \frac{{K}_{fz , uz}}{{K}_{fx , ux}} \frac{{K}_{fx , uz}}{{K}_{fz , uz}} \\ {T}_{fw , y} = {T}_{fy , xy} + {T}_{fy , zy} = \frac{{n}_{x}}{{n}_{y}} \frac{{K}_{fx , ux}}{{K}_{fy , uy}} \frac{{K}_{fy , ux}}{{K}_{fx , ux}} + \frac{{n}_{z}}{{n}_{y}} \frac{{K}_{fz , uz}}{{K}_{fy , uy}} \frac{{K}_{fy , uz}}{{K}_{fz , uz}}\end{matrix} \\ {T}_{fw , z} = {T}_{fz , xz} + {T}_{fz , yz} = \frac{{n}_{x}}{{n}_{z}} \frac{{K}_{fx , ux}}{{K}_{fz , uz}} \frac{{K}_{fz , ux}}{{K}_{fx , ux}} + \frac{{n}_{y}}{{n}_{z}} \frac{{K}_{fy , uy}}{{K}_{fz , uz}} \frac{{K}_{fz , uy}}{{K}_{fy , uy}}\end{matrix} . \qquad ( 21 )$$

Further, different types of force measurement branches correspond to different structure parameters that need to be optimized. For instance, when the force measurement branch is a cross straight circular force measurement branch, its structure parameters include the overall thickness in the y and z directions, the minimum thickness in the y and z directions, and the length in the x, y, and z directions.

Herein, in the iterative adjustment process, each time the elastic resistance error coefficients in three directions that ignore the deformation factors are minimized. The final convergence state means that even if the structure parameters are adjusted again, these three coefficients will no longer decrease or even increase. Moreover, during the adjustment process, more attention can be paid to the coefficients in one or two directions, slightly sacrificing the coefficients in the remaining directions.
4) Based on the latest structural optimization scheme of the force measurement branches, a finite element model of the entire force measurement system is constructed.
5) The load-measurement ratio is calculated, and the load-measurement ratio and the non-branch structure evaluation coefficient vector calculated by formula (18) are used to optimize the non-branch structure in the force measurement system. The specific process is as follows: the load-measurement ratios η_{f,x}, η_{f,y}, and η_{f,z} in the three orthogonal directions are calculated, and the non-branching structure evaluation coefficients in the three orthogonal directions are calculated according to formula (18). It is determined whether the non-branch structure evaluation coefficients in each direction (i.e., three orthogonal directions) are all less than the set evaluation threshold: if not, the structure parameters of the non-branch structure are adjusted, and step 5) is re-executed for iteration until the non-branch structure evaluation coefficients in the three orthogonal directions are all less than the set evaluation threshold.

It can be seen from formula (18) that the non-branch structure evaluation coefficients in the x, y, and z directions are the difference values between the elastic resistance error coefficients T_{f,x}, T_{f,y}, and T_{f,z} in the x, y, and z directions considering the deformation factor and the elastic resistance error coefficients T_{fw,x}, T_{fw,y}, and T_{fw,z} in the x, y, and z directions ignoring the deformation factor. Further, combined with the section “IV. Load Balance and Elastic Resistance of Measurement System”, it can be seen that the elastic resistance error coefficients T_{f,x}, T_{f,y}, and T_{f,z} considering the deformation factor are equal to the load-measurement ratio in the corresponding direction minus 1, that is, n_{f,x}−1, n_{f,y}−1, and n_{f,z}−1, respectively.

The optimization goal here is to set the non-branch structure evaluation coefficients in the three orthogonal directions to be less than the set evaluation threshold rather than to minimize the non-branch structure evaluation coefficients in the three orthogonal directions. This is because when the non-branch structure evaluation coefficients are minimized, the costs of the entire force measurement system will be higher. It is not necessary to minimize the evaluation coefficients in the three directions to achieve the goal.
6) After the structural optimization of the non-branch structure, the force measurement branch deformation extraction is performed to obtain the deformation ratio matrix Uₑ. The formula refers to formula (20). The deformation ratio matrix is used to evaluate whether the stability of the force measurement system satisfies the stability requirements. When the stability does not satisfy the requirements, the structure parameters of the force measurement system are modified and adjusted. Herein, the structure parameters of the force measurement system include the structure parameters of the branch structure mentioned in the above step 3) and the structure parameters of the non-branch structure mentioned in step 5), and the adjustment herein is different from the adjustment in step 3) and step 5). The adjustment herein is fine-tuning, and step 6) is re-executed for iteration until the stability of the force measurement system satisfies the requirements. When the stability satisfies the stability requirements, the design optimization of the structure parameters of the force measurement system is completed.

Herein, when the deformation ratio matrix selects Uₑ in formula (20), the stability of the force measurement system satisfies the requirements, which means that the closer each element in the deformation ratio matrix is to 1, the better. Specifically, the difference value between the trace or norm of Uₑ and the trace or norm of the ideal deformation ratio matrix U₁ corresponding to Uₑ can be used to determine the optimization result. Certainly, when the deformation ratio matrix selects U in formula (19), the stability of the system may be evaluated according to the content introduced in Section VII. Deformation Ratio Stability and Layout Design.

It should be noted that the content of step 6) is to consider the influence of deformation on the entire force measurement system when the stiffness is designed. Further, in the whole scheme, only the elastic resistance error is selected for the design of the force measurement system because the correlation between the interference error and the structure parameters is low.

### IX. Verification Instructions

The method of the disclosure is described in detail below by taking a specific force measurement system as an example. The design indicators include: (1) the axial force (Pₓ) load is 150 kN, and the in-situ calibration uncertainty is 1% FS, (2) the normal force (P_{y}) load is −100 kN, and the in-situ calibration uncertainty is 1.5% FS, (3) the pitch moment (M_{z}) is 50 kN·m, and the in-situ calibration uncertainty is 1.5% FS, (4) the lateral force (P_{Z}) is 50 kN, (5) the height of the engine from the installation plane is 2.6 m, (6) the interference between the two components is less than 5%, and the comprehensive interference is less than 10%, and (7) the model weight is 100 kN.

### 1) Selection of Force Measurement Branch Layout

The characteristics of the force measurement system tests are that the load center is high from the force measurement system surface, while the structural requirements are usually small. In order to ensure the stability of the support, four groups of force measurement branches are designed in the y direction, and four-point outer supports are adopted to maximize the support effect. Two groups of force measurement branches are designed in the x direction, and two groups of force measurement branches are designed in the z direction. According to the analysis result of the symmetrical arrangement of the horizontal units, the force measurement branches in the x direction and the z direction are distributed in a centrally symmetrical manner on the inner side of the lower part of the moving frame. The basic layout is shown in FIG. 5, where x5 and x8 are x-direction force measurement branches, y1 to y4 are y-direction force measurement branches, z7 and z8 are z-direction force measurement branches, 6 is the x-direction moving frame support, and 7 is the x-direction fixed frame support.

The specific information of the layout coordinates of the force measurement branches is shown in Table 1. The position vector in the static mapping matrix Gₛ uses the fixed frame coordinates, and the coordinate origin is set as the center of the bottom surface of the fixed frame. The overall layout mainly considers the bearing stability and moment measurement requirements. According to the layout in FIG. 5, i in Table 1 represents the i^{th} force measurement branch in FIG. 5, and the information of each force measurement branch mainly includes the connection coordinate rₛᵢ with the fixed frame, the connection coordinate tₛᵢ with the moving frame, and the force measurement direction sₛᵢ.

TABLE 1
Force measurement branch information table

| i | rₛᵢ/(mm) | tₛᵢ/(mm) | sₛᵢ/(m) |
|---|---|---|---|
| 1 | (−1360, 100, −320) | (−1360, 635, −320) | (0, 1, 0) |
| 2 | (−1360, 100, 320) | (−1360, 635, 320) | (0, 1, 0) |
| 3 | (1360, 100, 320) | (1360, 635, 320) | (0, 1, 0) |
| 4 | (1360, 100, −320) | (1360, 635, −320) | (0, 1, 0) |
| 5 | (−470, 390, −300) | (−40, 390, −300) | (1, 0, 0) |
| 6 | (470, 390, 300) | (40, 390, 300) | (−1, 0, 0) |
| 7 | (−1100, 515, 180) | (−1100, 515, −180) | (0, 0, −1) |
| 8 | (1100, 515, −180) | (1100, 515, 180) | (0, 0, 1) |

### 2) Design of Force Measurement Branch Structure in Force Measurement System

The external load force wrench of the force measurement system including gravity may be expressed as:

$${W}_{s} = [ \begin{matrix}150000 & - 200000 & 50000 & 167500 & 0 & - 552500\end{matrix} ] ( N ) . \qquad ( 22 )$$

The axial load fₛ of the eight force measurement branches may be obtained according to the following expression:

$${f}_{s} = {K}_{s} {{G}_{s}^{T} ( {G}_{s} {K}_{s} {G}_{s}^{T} )}^{- 1} {W}_{s} , \qquad ( 23 )$$

where

$${G}_{s} = [ \begin{matrix}{s}_{s 1} & {s}_{s 2} & ⋯ & {s}_{s 8} \\ {r}_{s 1} \times {s}_{s 1} & {r}_{s 2} \times {s}_{s 2} & ⋯ & {r}_{s 8} \times {s}_{s 8}\end{matrix} ] ,$$

is calculated from the data in Table 1, Kₛ=diag(k₁ k₂ . . . k₈), k₁, k₂ . . . k₈, are the axial stiffnesses of the 8 force measurement branches, which can be assigned large values initially, such as 1×10⁹ N/m.

According to formula (18), the axial loads of the eight branches of the eight-branch force measurement system under the given load conditions are:

$${f}_{s} = [ \begin{matrix}151551 & - 69933 & - 251550 & - 30067 & 75000 & - 75000 & 25000 & - 25000\end{matrix} ] ( N ) . \qquad ( 24 )$$

In order to reduce the deformation error, the axial deformation of all force measurement branches is limited to less than 0.5 mm, so the minimum axial stiffness of the force measurement branches in the three directions is:

$${K}_{s} = diag ( [ \begin{matrix}1.5 \times 1 {0}^{8} & 3 \times 1 {0}^{8} & 0.5 \times 1 {0}^{8}\end{matrix} ] ) ( N / m ) . \qquad ( 25 )$$

The load ranges in the three directions are different, so a force measurement branch with symmetrically arranged flexible hinges is selected.

Referring to formula (21), the elastic resistance error coefficient of the eight-branch force measurement system ignoring the deformation factor is expressed as:

$$\{ \begin{matrix}\begin{matrix}{T}_{fw , x} = 2 \frac{{K}_{fy , uy}}{{K}_{fx , ux}} \frac{{K}_{fx , uy}}{{K}_{fy , uy}} + \frac{{K}_{fz , uz}}{{K}_{fx , ux}} \frac{{K}_{fx , uz}}{{K}_{fz , uz}} \\ {T}_{fw , y} = \frac{1}{2} \frac{{K}_{fx , ux}}{{K}_{fy , uy}} \frac{{K}_{fy , ux}}{{K}_{fx , ux}} + \frac{1}{2} \frac{{K}_{fz , uz}}{{K}_{fy , uy}} \frac{{K}_{fy , uz}}{{K}_{fz , uz}}\end{matrix} \\ {T}_{fw , z} = \frac{{K}_{fx , ux}}{{K}_{fz , uz}} \frac{{K}_{fz , ux}}{{K}_{fx , ux}} + 2 \frac{{K}_{fy , uy}}{{K}_{fz , uz}} \frac{{K}_{fz , uy}}{{K}_{fy , uy}}\end{matrix} . \qquad ( 26 )$$

With the goal of minimizing the elastic resistance error coefficient ignoring the deformation factor in three directions, the structure parameters of the force measurement branch are adjusted in combination with finite element simulation. During the design process, it is necessary to ensure that the flexible hinge of the force measurement branch has sufficient design stiffness and fatigue strength, and sufficient deformation restoring force needs to be reserved.

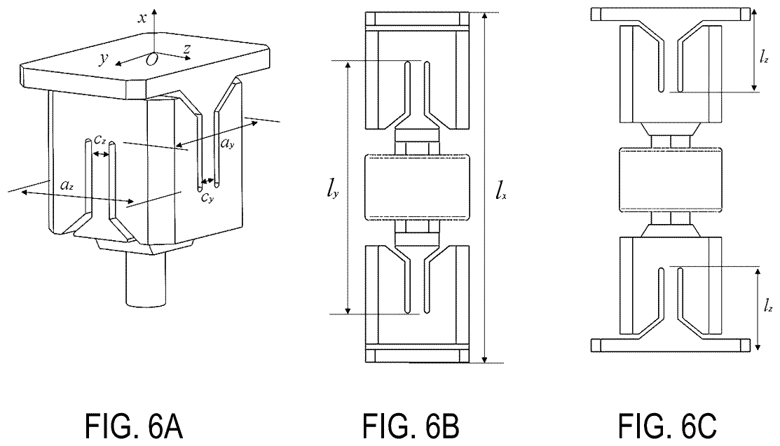

Considering the measurement requirements, actual working conditions and processing convenience, a symmetrical cross straight circle force measurement branch is selected. The main parameters of the symmetrical cross straight circle force measurement branch are 7, including the overall thickness a_{y} and a_{z}, the minimum thickness c_{z} and c_{y}, and the length lₓ, l_{y}, and l_{z}, as shown in FIG. 6A to FIG. 6C. Through the finite element model, the design parameters are adjusted and iterated multiple times, and the structure parameters of the force measurement branches in three orthogonal directions are obtained as shown in Table 2.

TABLE 2
Force measurement branch parameter table

| Direction | x/(m) | y/(m) | z/(m) |
|---|---|---|---|
| a_{y} | 0.13 | 0.15 | 0.1 |
| a_{z} | 0.13 | 0.15 | 0.1 |
| c_{y} | 0.02 | 0.02 | 0.013 |
| c_{z} | 0.02 | 0.02 | 0.013 |
| lₓ | 0.47 | 0.535 | 0.36 |
| l_{y} | 0.33 | 0.4 | 0.25 |
| l_{z} | 0.125 | 0.14 | 0.105 |

The axial stiffness (K_{Qx,j}) and lateral deformation stiffness (K_{Qy,j}, K_{Qz,j}) of the force measurement branch in the j direction are designed by the finite element method. When obtaining the stiffness of the force measurement branch, only the displacement in the j direction of the end surface of the force measurement branch is set to a free state, and the displacement in the other directions is set to a constant of 0.

According to the measurement requirements, the measurement accuracy in the x-direction is relatively high. Therefore, in the process of configuring the lateral compliance of the force measurement branch, the elastic resistance error coefficient T_{fw,x} in the x-direction ignoring the deformation factor should be reduced as much as possible while satisfying the overall requirements. After repeated optimization design, the axial stiffness and lateral deformation stiffness of the force measurement branch are obtained as shown in the table.

TABLE 3
Stiffness of the force measurement branch
in the local coordinate system

| j | k_{Qj, x}/(N/m) | k_{Qj, y}/(N/m) | k_{Qj, z}/(N/m) |
|---|---|---|---|
| x | 5.664 × 108 | 1.354 × 106 | 3.144 × 106 |
| y | 6.141 × 108 | 4.011 × 106 | 4.556 × 106 |
| z | 1.658 × 108 | 1.921 × 106 | 1.966 × 106 |

The material selection of the flexible hinges mainly considers the material's restoring force and linear elastic stability. Priority is given to materials with low internal energy consumption and small creep. High-purity metals and the cobalt and chromium components in alloys can strengthen the material lattice and reduce dislocations. Further, the heat treatment process can also change the material's microstructure and enhance structural stability. Therefore, 60Si2Cr is selected as the material of the flexible hinges in the force measurement branches. Further, the above structure satisfies the fatigue strength requirements under the full load axial force and lateral load of 5% of the axial force.

### 3) Non-Branch Structure Stiffness Design

Structures other than the force measurement branches, such as the moving platform and supports, are uniformly defined as the non-branch structures. Generally, when the axial stiffness and compliance ratio of the force measurement branch are optimized to a certain extent, it is necessary to optimize the stiffness of the non-branch structure. The non-branch structure stiffness is optimized by taking the deviation of the elastic resistance error coefficient considering the deformation factor and the elastic resistance error coefficient ignoring the deformation factor as the optimization target. Finally, the elastic resistance error coefficient contribution η_{i,j} (i.e., ηᵢ in Table 4) of the non-branch structure and related information are obtained as shown in Table 4.

TABLE 4
Load-to-measurement ratio design and structural stiffness design

| Direction | T_{fw, i} | η_{f, i} | T_{fe, i} | ηₜ |
|---|---|---|---|---|
| x | 0.0176 | 1.042405 | 0.042405 | 0.024805 |
| y | 0.0027 | 1.007291 | 0.007291 | 0.004591 |
| z | 0.0739 | 1.085018 | 0.085018 | 0.011118 |

Some people believe that the stiffness of the force measurement branch analyzed separately is different from that when it is loaded in the force measurement system, so the separate design is inaccurate. This phenomenon is mainly caused by the load distribution of the force measurement branch. Therefore, during the simulation of the force measurement branch, a rigid body is placed on its free end surface and some degrees of freedom of the rigid body are restricted. This arrangement ensures the consistency between the individual analysis performance of the force measurement branch and the actual performance in the force measurement system.

### 4) Stability Analysis of Force Measurement System

A single-component remote force is applied to the force measurement system, the action surface is selected as the surface of the moving frame. The large deflection setting is turned on, and the remote loads in three directions are applied to the center of the force branch distribution circle in each direction. The axial force, shear force, and bending moment at the upper and lower surfaces of the beam connection unit of each force measurement branch are obtained. When the y-axis load component is applied, a rectangular block is placed on the upper surface of the moving frame to serve as a mounting frame. The rectangular block is set as a rigid body, and the load is applied. The force and deformation of the 8 force measurement branches are collected, and the specific information is shown in Tables 5, 7, and 9. The “force measurement elements” all bear certain shear forces and bending moments, and the magnitude of the shear force is related to the non-measurement direction load, the branch stiffness ratio between the components of the flexible hinge and the compliance ratio of the force measurement branch. This is also a major advantage of the elastic resistance error coefficient in characterizing structural performance in a proportional form.

In order to approach the working condition of consolidating the model to be tested on the upper surface of the moving frame, when simulating the load of the y-direction load component, a rectangular block is placed on the upper surface of the moving frame to serve as a mounting frame. The rectangular block is set as a rigid body, and the load is applied to collect the force and deformation of the 8 force measurement branches. In addition, the deformation displacement at the end surface of each force measurement branch is obtained. The specific information is shown in Table 6, Table 8, and Table 10. The deformation range of the designed force measurement system is within 0.4 mm, which satisfies the required deformation requirement within 0.5 mm.

TABLE 5
Branch force at “Pₓ = 150 kN”

| | Branch number | | | | | | | |
|---|---|---|---|---|---|---|---|---|
| | 1 | 2 | 3 | 4 | 5 | 6 | 7 | 8 |
| Axial | −722.402 | 384.497 | 687.033 | −388.037 | 71986.6 | −71911.4 | 110.972 | −118.693 |
| force/N | | | | | | | | |
| Shear | 1150.51 | 1168.07 | 1150.41 | 1167.84 | 1211.4 | 1243.32 | 734.506 | 734.168 |
| force/N | | | | | | | | |
| Upper | 72.8235 | 74.8478 | 72.6002 | 75.1122 | 42.1378 | 69.4438 | 23.6324 | 23.4856 |
| bending | | | | | | | | |
| moment/ | | | | | | | | |
| (N · m) | | | | | | | | |
| Lower | 65.2713 | 65.337 | 65.4822 | 65.0448 | 67.1679 | 43.1716 | 23.3789 | 23.5024 |
| bending | | | | | | | | |
| moment/ | | | | | | | | |
| (N · m) | | | | | | | | |

TABLE 6
“Pₓ = 150 kN” branch deformation displacement

| Branch number | 1 | 2 | 3 | 4 | 5 | 6 | 7 | 8 |
|---|---|---|---|---|---|---|---|---|
| x direction (m) | 3.86 × | 3.87 × | 3.86 × | 3.87 × | 2.13 × | 2.13 × | 3.92 × | 3.93 × |
| | 10⁻⁰⁴ | 10⁻⁰⁴ | 10⁻⁰⁴ | 10⁻⁰⁴ | 10⁻⁰⁴ | 10⁻⁰⁴ | 10⁻⁰⁴ | 10⁻⁰⁴ |
| y direction (m) | 1.34 × | 2.50 × | −1.85 × | −2.92 × | 1.45 × | −1.59 × | 1.76 × | −1.85 × |
| | 10⁻⁰⁶ | 10⁻⁰⁶ | 10⁻⁰⁶ | 10⁻⁰⁶ | 10⁻⁰⁵ | 10⁻⁰⁵ | 10⁻⁰⁵ | 10⁻⁰⁵ |
| z direction (m) | −3.19 × | −3.70 × | −4.08 × | −4.59 × | 9.64 × | 1.04 × | −1.95 × | −9.31 × |
| | 10⁻⁰⁶ | 10⁻⁰⁶ | 10⁻⁰⁶ | 10⁻⁰⁶ | 10⁻⁰⁶ | 10⁻⁰⁵ | 10⁻⁰⁷ | 10⁻⁰⁷ |

TABLE 7
Branch force at “P_{y} = 100 kN”

| | Branch number | | | | | | | |
|---|---|---|---|---|---|---|---|---|
| | 1 | 2 | 3 | 4 | 5 | 6 | 7 | 8 |
| Axial | 24376 | 25262.2 | 24376.6 | 25261.4 | 154.735 | 157.282 | −67.2782 | −66.0364 |
| force/N | | | | | | | | |
| Shear | 79.6174 | 73.8711 | 80.2025 | 75.6447 | 242.685 | 242.996 | 121.966 | 121.881 |
| force/N | | | | | | | | |
| Upper | 10.3164 | 1.78873 | 0.793326 | 1.43586 | 10.9323 | 10.9923 | 3.90989 | 3.87876 |
| bending | | | | | | | | |
| moment/ | | | | | | | | |
| (N · m) | | | | | | | | |
| Lower | 0.82721 | 9.57293 | 10.2736 | 9.71333 | 10.9095 | 10.8775 | 3.89783 | 3.9234 |
| bending | | | | | | | | |
| moment/ | | | | | | | | |
| (N · m) | | | | | | | | |

TABLE 8
Branch deformation at “P_{y} = 100 kN”

| Branch number | 1 | 2 | 3 | 4 | 5 | 6 | 7 | 8 |
|---|---|---|---|---|---|---|---|---|
| x direction (m) | 5.06 × | −4.66 × | −4.29 × | 5.98 × | 8.15 × | −7.42 × | 5.64 × | −5.23 × |
| | 10⁻⁰⁷ | 10⁻⁰⁷ | 10⁻⁰⁷ | 10⁻⁰⁷ | 10⁻⁰⁷ | 10⁻⁰⁷ | 10⁻⁰⁷ | 10⁻⁰⁷ |
| y direction (m) | 6.14 × | 6.14 × | 6.14 × | 6.12 × | 6.26 × | 6.29 × | 6.27 × | 6.28 × |
| | 10⁻⁰⁵ | 10⁻⁰⁵ | 10⁻⁰⁵ | 10⁻⁰⁵ | 10⁻⁰⁵ | 10⁻⁰⁵ | 10⁻⁰⁵ | 10⁻⁰⁵ |
| z direction (m) | −2.35 × | −2.84 × | 2.16 × | 2.64 × | 2.18 × | −1.89 × | −1.81 × | 1.64 × |
| | 10⁻⁰⁶ | 10⁻⁰⁶ | 10⁻⁰⁶ | 10⁻⁰⁶ | 10⁻⁰⁸ | 10⁻⁰⁸ | 10⁻⁰⁶ | 10⁻⁰⁶ |

TABLE 9
Branch force at “P_{z} = 50 kN”

| | Branch number | | | | | | | |
|---|---|---|---|---|---|---|---|---|
| | 1 | 2 | 3 | 4 | 5 | 6 | 7 | 8 |
| Axial | 361.339 | −184.774 | −371.992 | 186.716 | 0.996273 | −6.03794 | −23039.2 | 23043 |
| force/N | | | | | | | | |
| Shear | 479.67 | 554.729 | 478.304 | 554.669 | 929.93 | 930.642 | 202.244 | 194.59 |
| force/N | | | | | | | | |
| Upper | 22.9837 | 37.5542 | 22.9653 | 37.5839 | 42.3399 | 41.5789 | 5.68379 | 5.14994 |
| bending | | | | | | | | |
| moment/ | | | | | | | | |
| (N · m) | | | | | | | | |
| Lower | 34.5831 | 29.0305 | 34.4335 | 28.9949 | 41.3584 | 42.1826 | 7.26255 | 7.30519 |
| bending | | | | | | | | |
| moment/ | | | | | | | | |
| (N · m) | | | | | | | | |

TABLE 10
Branch deformation at “P_{z} = 50 kN”

| Branch number | 1 | 2 | 3 | 4 | 5 | 6 | 7 | 8 |
|---|---|---|---|---|---|---|---|---|
| x direction (m) | 5.49 × | −3.07 × | 6.60 × | −3.17 × | 3.17 × | 4.51 × | −1.67 × | −1.63 × |
| | 10⁻⁰⁷ | 10⁻⁰⁶ | 10⁻⁰⁷ | 10⁻⁰⁶ | 10⁻⁰⁷ | 10⁻⁰⁷ | 10⁻⁰⁶ | 10⁻⁰⁶ |
| y direction (m) | 3.46 × | −5.37 × | −3.55 × | 5.04 × | −2.30 × | 2.27 × | −1.00 × | 1.01 × |
| | 10⁻⁰⁶ | 10⁻⁰⁶ | 10⁻⁰⁶ | 10⁻⁰⁶ | 10⁻⁰⁵ | 10⁻⁰⁵ | 10⁻⁰⁵ | 10⁻⁰⁵ |
| z direction (m) | 1.77 × | 1.80 × | 1.77 × | 1.80 × | 2.09 × | 2.09 × | 1.59 × | 1.59 × |
| | 10⁻⁰⁴ | 10⁻⁰⁴ | 10⁻⁰⁴ | 10⁻⁰⁴ | 10⁻⁰⁴ | 10⁻⁰⁴ | 10⁻⁰⁴ | 10⁻⁰⁴ |

It can be seen from Table 7 that the data of the force measurement branches in the x direction and the z direction caused by the y direction are relatively large, but the centrally symmetrical structure makes it possible for the y-direction load to have less interference on the force measurement components in the x direction and the z direction after the components are synthesized. The average data of branch deformation in three directions are calculated from the data in Table 6, Table 8, and Table 10, and the deformation ratio matrix is further obtained as follows:

$${U}_{e} = [ \begin{matrix}1 & 1.82 & 1.84 \\ 1.02 & 1 & 1.02 \\ 1.31 & 1.21 & 1\end{matrix} ] . \qquad ( 27 )$$

The deformation ratio matrix shown in formula (27) reaches a relatively suitable state. If the influence of factors such as size is released, the deformation ratio matrix can be further optimized.

### Embodiments of Structure Optimization Method of Force Measurement Branches in Force Measurement System

The core idea of an embodiment of a structure optimization method of force measurement branches in a force measurement system of the disclosure is to use the elastic resistance error ignoring the deformation factor as an optimization indicator to optimize the structure of the force measurement branches in the force measurement system, so as to ensure the accuracy of structural analysis and design. The specific optimization process can be seen in steps 1) to 3) of “VIII. Method Flow” of the embodiment of the structure optimization method of the force measurement system. Description thereof is not repeated in this embodiment again.

### Computer Apparatus Embodiment 1:

In the computer apparatus embodiment of the disclosure, a memory, a processor, an internal bus, and a computer program stored in the memory are included. The processor and the memory communicate and exchange data with each other through the internal bus. The processor executes the computer program to implement the steps of the structure optimization method of the force measurement system introduced in the embodiments of the structure optimization method of the force measurement system of the disclosure. Herein, the processor may be a microprocessor MCU, a programmable logic device FPGA or other processing device. The memory may be various memories that use electrical energy to store information, such as RAM, ROM, etc., or may be a memory that uses other methods.

### Computer Apparatus Embodiment 2:

In the computer apparatus embodiment of the disclosure, a memory, a processor, an internal bus, and a computer program stored in the memory are included. The processor and the memory communicate and exchange data with each other through the internal bus. The processor executes the computer program to implement the steps of the structure optimization method of the force measurement branches in the force measurement system introduced in the embodiments of the structure optimization method of the force measurement branches in the force measurement system of the disclosure. Herein, the processor may be a microprocessor MCU, a programmable logic device FPGA or other processing device. The memory may be various memories that use electrical energy to store information, such as RAM, ROM, etc., or may be a memory that uses other methods.

### Embodiments of Force Measurement System

An embodiment of a force measurement system of the disclosure is a force measurement system designed according to a structure optimization method of a force measurement system introduced in an embodiment of the structure optimization method of the force measurement system. The specific detailed process of this method has been described in detail in the embodiment of the structure optimization method of the force measurement system, and description thereof is not repeated in this embodiment.

In view of the foregoing, the disclosure has the following characteristics: 1) The elastic resistance error, a positive design indicator strongly associated with the structural parameters of the force measurement system, is used, and a theoretical analytical expression reflecting the relationship between the elastic resistance error and the key structural parameters is established. The elastic resistance error is one of the main components of the coupling error. The structure parameters involved in elastic resistance error are relatively comprehensive and have a high correlation with the structure parameters of the force measurement system, so that the accuracy of structural analysis and design is ensured. 2) In the disclosure, theoretical design and finite element model are fully combined, so that the efficiency of structural forward design is improved, and the structural design parameters of the force measurement system are determined from the two aspects: structural stiffness and deformation. As such, the advantages of theoretical methods in analyzing the relationship between structure performance and design parameters as well as finite element models in precise calculation of deformation and local loads are fully leveraged. 3) The design of main structure parameters of the force measurement system is divided into three parts in the entire scheme: structure parameter optimization of force measurement branches, structure parameter optimization of non-branch structures, and structure parameter fine-tuning of the entire force measurement system. Moreover, quantitative design is performed on each part. Therefore, the design efficiency and accuracy of the force measurement system are improved.

The above description is specific implementations of the present disclosure, but the present disclosure is not limited thereto. The basic idea of the present disclosure lies in the foregoing basic solutions. For those of ordinary skill in the art, based on the teaching of the present disclosure, designing various variant models, formulas, and parameters does not require creative work. Changes, modifications, replacements, and variations made to the embodiments without departing from the principle and spirit of the present disclosure still fall within the protection scope of the present disclosure.

What is claimed is:

1. A structure optimization method of force measurement branches in a force measurement system, comprising:
1) constructing a simulation model of the force measurement branches according to initial structure parameters of the force measurement branches;
2) judging whether force measurement branch indicators meet a standard by using the latest simulation model of the force measurement branches: if not, adjusting the structure parameters of the force measurement branches to lower the force measurement branch indicators, re-determining the simulation model of the force measurement branches, and re-executing step 2) for iteration until the standard is met;
wherein the force measurement branch indicators are elastic resistance error coefficients ignoring deformation factors in three directions, wherein the elastic resistance error coefficient ignoring the deformation factor in a specific direction is a sum of the elastic resistance error coefficients ignoring the deformation factors generated by the force measurement branches in the other two directions on the force measurement in the specific direction, and the elastic resistance error coefficient ignoring the deformation factor generated by the force measurement branch in one of the other two directions on the force measurement in the specific direction is a product of a number ratio of the force measurement branches in the one of the other two directions to the force measurement branches in the specific direction, an axial stiffness ratio of the force measurement branch in the one of the other two directions direction to the force measurement branch in the specific direction, and a ratio of lateral deviation stiffness of the force measurement branch in the one of the other two directions direction to axial stiffness of the force measurement branch in the one of the other two directions.

2. The structure optimization method of the force measurement branches in the force measurement system according to claim 1, wherein the simulation model is a finite element simulation model.

3. A computer apparatus comprising a processor executing a computer program to implement the steps of the method according to claim 1.

4. A structure optimization method of a force measurement system, comprising:
1) constructing a simulation model of force measurement branches in the force measurement system according to initial structure parameters of the force measurement branches;
2) judging whether force measurement branch indicators meet a standard by using the latest simulation model of the force measurement branches: if not, adjusting the structure parameters of the force measurement branches to lower the force measurement branch indicators, re-determining the simulation model of the force measurement branches, and re-executing step 2) for iteration until the standard is met; if the standard is met, executing step 3);
wherein the force measurement branch indicators are elastic resistance error coefficients ignoring deformation factors in three directions, wherein the elastic resistance error coefficient ignoring the deformation factor in a specific direction is a sum of the elastic resistance error coefficients ignoring the deformation factors generated by the force measurement branches in the other two directions on the force measurement in the specific direction, and the elastic resistance error coefficient ignoring the deformation factor generated by the force measurement branch in one of the other two directions on the force measurement in the specific direction is a product of a number ratio of the force measurement branches in the one of the other two directions to the force measurement branches in the specific direction, an axial stiffness ratio of the force measurement branch in the one of the other two directions to the force measurement branch in the specific direction, and a ratio of lateral deviation stiffness of the force measurement branch in the one of the other two directions to axial stiffness of the force measurement branch in the one of the other two directions;
3) constructing a simulation model of the force measurement system according to initial structure parameters of non-branch structures and the structure parameters of the force measurement branches finally determined in step 2), wherein the non-branch structures are structures in the force measurement system other than the force measurement branches; and
4) judging whether non-branch structure indicators meet the standard by using the latest simulation model of the force measurement system: if not, adjusting the structure parameters of the non-branch structures, re-determining the simulation model of the force measurement system, and re-executing step 4) for iteration until the non-branch structure indicators meet the standard.

5. The structure optimization method of the force measurement system according to claim 4, wherein each non-branch structure indicator in step 4) is a non-branch structure evaluation coefficient in each direction, and the non-branch structure evaluation coefficient in a specific direction is a difference value between the elastic resistance error coefficient considering the deformation factors in the specific certain direction and the elastic resistance error coefficient ignoring the deformation factors in the specific direction,
wherein the elastic resistance error coefficient considering the deformation factors in a specific direction is a sum of the elastic resistance error coefficients considering the deformation factors generated by the force measurement branches in the other two directions on the force measurement in the specific direction, and the elastic resistance error coefficient considering the deformation factors is:
$$\begin{matrix}{T}_{fi , ji} = \frac{{n}_{j}}{{n}_{i}} \frac{{K}_{fj , uj}}{{K}_{fi , ui}} ( \frac{{K}_{fi , uj}}{{K}_{fj , uj}} \frac{{\overline{u}}_{Gi , j}}{{\overline{u}}_{Gi , i}} + \frac{{K}_{fk , θ j}}{{K}_{fj , uj}} \frac{{\overline{θ}}_{Gk , j}}{{\overline{u}}_{Gi , i}} ) & i , j , k ∈\end{matrix} \{ \begin{matrix}x & y & z\end{matrix} \} , i \neq j \neq k ,$$
wherein T_{fi,ji} represents the elastic resistance error coefficient generated by the i-direction force measurement branch on the force measurement in a y direction, nᵢ represents the number of i-direction force measurement branches, nⱼ represents the number of j-direction force measurement branches, K_{fi,ui} represents i-direction displacement stiffness caused by an i-direction force component of the i-direction force measurement branch in a global coordinate system and referred to as axial stiffness of the i-direction force measurement branch, K_{fj,uj} represents j-direction displacement stiffness caused by a j-direction force component of the j-direction force measurement branch in the global coordinate system and referred to as axial stiffness of the j-direction force measurement branch, K_{fi,uj} represents i-direction displacement stiffness caused by an i-direction force component of the j-direction force measurement branch in the global coordinate system and referred to as axial stiffness of the j-direction force measurement branch, K_{fk,θj} represents bending stiffness surrounding a k direction caused by a moment component of the j-direction force measurement branch surrounding the k direction in the global coordinate system, ū_{Gi,i} represents an average value of i-direction displacement of the i-direction force measurement branch under the global coordinate system, ū_{Gi,j} represents an average value of i-direction displacement of the j-direction force measurement branch under the global coordinate system, and θ̅_{Gk,j} represents an average value of the j-direction force measurement branch bending surrounding the k direction under the global coordinate system,
the non-branch structure indicators meeting the indicator requirements means that the non-branch structure evaluation coefficients in all directions are less than a set evaluation threshold.

6. The structure optimization method of the force measurement system according to claim 5, wherein the elastic resistance error coefficient considering the deformation factor in a specific direction is a load-to-measurement ratio in that specific direction minus 1, and the load-to-measurement ratio is a ratio of an applied load to the force component synthesized by the force measurement branches.

7. The structure optimization method of the force measurement system according to claim 4, further comprising:
5) determining a simulation model of the force measurement system using the structure parameters of the force measurement system finally determined in step 4);
6) evaluating whether stability of the force measurement system satisfies stability requirements by using the latest simulation model of the force measurement system: if satisfied, structure optimization of the entire force measurement system is completed; if not satisfied, fine-tuning the structure parameters of the force measurement system, re-determining the simulation model of the force measurement system using the fine-tuned structure parameters, and re-executing step 6) for iteration until the stability of the force measurement system satisfies the stability requirements.

8. The structure optimization method of the force measurement system according to claim 7, wherein in step 3) the stability is evaluated according to a deformation ratio matrix, and the deformation ratio matrix is:
$$U = [ \begin{matrix}{\overline{u}}_{Gy , x} / {\overline{u}}_{Gx , x} & {\overline{θ}}_{Gy , x} / {\overline{u}}_{Gx , x} & {\overline{u}}_{Gz , x} / {\overline{u}}_{Gx , x} & {\overline{θ}}_{Gz , x} / {\overline{u}}_{Gx , x} \\ {\overline{u}}_{Gx , y} / {\overline{u}}_{Gy , y} & {\overline{θ}}_{Gx , y} / {\overline{u}}_{Gy , y} & {\overline{u}}_{Gz , y} / {\overline{u}}_{Gy , y} & {\overline{θ}}_{Gz , y} / {\overline{u}}_{Gy , y} \\ {\overline{u}}_{Gx , z} / {\overline{u}}_{Gz , z} & {\overline{θ}}_{Gx , z} / {\overline{u}}_{Gz , z} & {\overline{u}}_{Gy , z} / {\overline{u}}_{Gz , z} & {\overline{θ}}_{Gz , z} / {\overline{u}}_{Gz , z}\end{matrix} ]$$
$$or$$
$${U}_{e} = [ \begin{matrix}{\overline{u}}_{Gx , x} / {\overline{u}}_{Gx , x} & {\overline{u}}_{Gx , y} / {\overline{u}}_{Gx , x} & {\overline{u}}_{Gx , z} / {\overline{u}}_{Gx , x} \\ {\overline{u}}_{Gy , x} / {\overline{u}}_{Gy , y} & {\overline{u}}_{Gy , y} / {\overline{u}}_{Gy , y} & {\overline{u}}_{Gy , z} / {\overline{u}}_{Gy , y} \\ {\overline{u}}_{Gz , x} / {\overline{u}}_{Gz , z} & {\overline{u}}_{Gz , y} / {\overline{u}}_{Gz , z} & {\overline{u}}_{Gz , z} / {\overline{u}}_{Gz , z}\end{matrix} ]$$
where U and Uₑ both represent deformation ratio matrices, ū_{Gy,x} represents an average value of y-direction displacement of the x-direction force measurement branch under the global coordinate system, ū_{Gx,x} represents an average value of x-direction displacement of the x-direction force measurement branch under the global coordinate system, ū_{Gx,y} represents an average value of x-direction displacement of the y-direction force measurement branch under the global coordinate system, ū_{Gy,y} represents an average value of y-direction displacement of the y-direction force measurement branch under the global coordinate system, ū_{Gx,z} represents an average value of x-direction displacement of the z-direction force measurement branch under the global coordinate system, ū_{Gz,z} represents an average value of z-direction displacement of the z-direction force measurement branch under the global coordinate system, θ̅_{Gy,x} represents an average value of the x-direction force measurement branch bending surrounding the y direction under the global coordinate system, θ̅_{Gx,y} represents an average value of the y-direction force measurement branch bending surrounding an x direction under the global coordinate system, θ_{Gx,z} represents an average value of the z-direction force measurement branch bending surrounding the x direction under the global coordinate system, ū_{Gz,x} represents an average value of z-direction displacement of the x-direction force measurement branch under the global coordinate system, ū_{Gz,y} represents an average value of z-direction displacement of the y-direction force measurement branch under the global coordinate system, ūGy,z represents an average value of y-direction displacement of the z-direction force measurement branch under the global coordinate system, θ̅_{Gz,x} represents an average value of the x-direction force measurement branch bending surrounding the z direction under the global coordinate system, θ̅_{Gz,y} represents an average value of the y-direction force measurement branch bending surrounding the z direction under the global coordinate system, and θ_{Gy,z} represents an average value of the z-direction force measurement branch bending surrounding the y direction under the global coordinate system,
wherein in the deformation ratio matrix Uₑ, the closer each element in the matrix is to 1, the better the stability of the force measurement system, in the deformation ratio matrix U, the closer the elements in a first column and a third column are to 1 and the closer the elements in a second column and a fourth column are to 0, the better the stability of the force measurement system.

9. The structure optimization method of the force measurement system according to claim 8, wherein the method of evaluating the stability according to the deformation ratio matrix is:
calculating a trace or a norm of the deformation ratio matrix Uₑ and correspondingly subtracting a trace or a norm of U₁ from the trace or the norm of the deformation ratio matrix Uₑ to obtain a corresponding difference value, wherein U₁ is an ideal deformation ratio matrix corresponding to Uₑ: if the obtained difference value is less than a corresponding set difference threshold, it is determined that the stability of the force measurement system satisfies the stability requirements; otherwise, it is determined that the stability of the force measurement system does not satisfy the stability requirements; or
calculating a trace or a norm of the matrix UU^{T} and correspondingly subtracting a trace or a norm of U₂U₂^{T} from the trace or the norm of the matrix UU^{T} to obtain a corresponding difference value, wherein U₂ is an ideal deformation ratio matrix corresponding to U: if the obtained difference value is less than a corresponding set difference threshold, it is determined that the stability of the force measurement system satisfies the stability requirements; otherwise, it is determined that the stability of the force measurement system does not satisfy the stability requirements.

10. The structure optimization method of the force measurement system according to claim 4, wherein the simulation model of the force measurement branches and the simulation model of the force measurement system are both finite element simulation models.

11. The structure optimization method of the force measurement system according to claim 5, further comprising:
5) determining a simulation model of the force measurement system using the structure parameters of the force measurement system finally determined in step 4);
6) evaluating whether stability of the force measurement system satisfies stability requirements by using the latest simulation model of the force measurement system: if satisfied, structure optimization of the entire force measurement system is completed; if not satisfied, fine-tuning the structure parameters of the force measurement system, re-determining the simulation model of the force measurement system using the fine-tuned structure parameters, and re-executing step 6) for iteration until the stability of the force measurement system satisfies the stability requirements.

12. The structure optimization method of the force measurement system according to claim 11, wherein in step 3) the stability is evaluated according to a deformation ratio matrix, and the deformation ratio matrix is:
$$U = [ \begin{matrix}{\overline{u}}_{Gy , x} / {\overline{u}}_{Gx , x} & {\overline{θ}}_{Gy , x} / {\overline{u}}_{Gx , x} & {\overline{u}}_{Gz , x} / {\overline{u}}_{Gx , x} & {\overline{θ}}_{Gz , x} / {\overline{u}}_{Gx , x} \\ {\overline{u}}_{Gx , y} / {\overline{u}}_{Gy , y} & {\overline{θ}}_{Gx , y} / {\overline{u}}_{Gy , y} & {\overline{u}}_{Gz , y} / {\overline{u}}_{Gy , y} & {\overline{θ}}_{Gz , y} / {\overline{u}}_{Gy , y} \\ {\overline{u}}_{Gx , z} / {\overline{u}}_{Gz , z} & {\overline{θ}}_{Gx , z} / {\overline{u}}_{Gz , z} & {\overline{u}}_{Gy , z} / {\overline{u}}_{Gz , z} & {\overline{θ}}_{Gz , z} / {\overline{u}}_{Gz , z}\end{matrix} ]$$
$$or$$
$${U}_{e} = [ \begin{matrix}{\overline{u}}_{Gx , x} / {\overline{u}}_{Gx , x} & {\overline{u}}_{Gx , y} / {\overline{u}}_{Gx , x} & {\overline{u}}_{Gx , z} / {\overline{u}}_{Gx , x} \\ {\overline{u}}_{Gy , x} / {\overline{u}}_{Gy , y} & {\overline{u}}_{Gy , y} / {\overline{u}}_{Gy , y} & {\overline{u}}_{Gy , z} / {\overline{u}}_{Gy , y} \\ {\overline{u}}_{Gz , x} / {\overline{u}}_{Gz , z} & {\overline{u}}_{Gz , y} / {\overline{u}}_{Gz , z} & {\overline{u}}_{Gz , z} / {\overline{u}}_{Gz , z}\end{matrix} ]$$
where U and Uₑ both represent deformation ratio matrices, ū_{Gy,x} represents an average value of y-direction displacement of the x-direction force measurement branch under the global coordinate system, ū_{Gx,x} represents an average value of x-direction displacement of the x-direction force measurement branch under the global coordinate system, ū_{Gx,y} represents an average value of x-direction displacement of the y-direction force measurement branch under the global coordinate system, ū_{Gy,y} represents an average value of y-direction displacement of the y-direction force measurement branch under the global coordinate system, ū_{Gx,z} represents an average value of x-direction displacement of the z-direction force measurement branch under the global coordinate system, ū_{Gz,z} represents an average value of z-direction displacement of the z-direction force measurement branch under the global coordinate system, θ̅_{Gy,x} represents an average value of the x-direction force measurement branch bending surrounding the y direction under the global coordinate system, θ̅_{Gx,y} represents an average value of the y-direction force measurement branch bending surrounding the x direction under the global coordinate system, θ̅_{Gx,z} represents an average value of the z-direction force measurement branch bending surrounding the x direction under the global coordinate system, ū_{Gz,x} represents an average value of the z-direction displacement of the x-direction force measurement branch under the global coordinate system, Ü_{Gz,y} represents an average value of z-direction displacement of the y-direction force measurement branch under the global coordinate system, ū_{Gy,z} represents an average value of y-direction displacement of the z-direction force measurement branch under the global coordinate system, θ̅_{Gz,x} represents an average value of the x-direction force measurement branch bending surrounding the z direction under the global coordinate system, θ̅_{Gz,y} represents an average value of the y-direction force measurement branch bending surrounding the z direction under the global coordinate system, and θ̅_{Gy,z} represents an average value of the z-direction force measurement branch bending surrounding the y direction under the global coordinate system,
wherein in the deformation ratio matrix Uₑ, the closer each element in the matrix is to 1, the better the stability of the force measurement system, in the deformation ratio matrix U, the closer the elements in a first column and a third column are to 1 and the closer the elements in a second column and a fourth column are to 0, the better the stability of the force measurement system.

13. The structure optimization method of the force measurement system according to claim 12, wherein the method of evaluating the stability according to the deformation ratio matrix is:
calculating a trace or a norm of the deformation ratio matrix Uₑ and correspondingly subtracting a trace or a norm of U₁ from the trace or the norm of the deformation ratio matrix Uₑ to obtain a corresponding difference value, wherein U₁ is an ideal deformation ratio matrix corresponding to Uₑ: if the obtained difference value is less than a corresponding set difference threshold, it is determined that the stability of the force measurement system satisfies the stability requirements; otherwise, it is determined that the stability of the force measurement system does not satisfy the stability requirements; or
calculating a trace or a norm of the matrix UU^{T} and correspondingly subtracting a trace or a norm of U₂U₂^{T} from the trace or the norm of the matrix UU^{T} to obtain a corresponding difference value, wherein U₂ is an ideal deformation ratio matrix corresponding to U: if the obtained difference value is less than a corresponding set difference threshold, it is determined that the stability of the force measurement system satisfies the stability requirements; otherwise, it is determined that the stability of the force measurement system does not satisfy the stability requirements.

14. A computer apparatus comprising a processor executing a computer program to implement the steps of the method according to claim 4.

15. A force measurement system, wherein the force measurement system is a force measurement system optimized by using the method according to claim 4.

16. A force measurement system, wherein the force measurement system is a force measurement system optimized by using the method according to claim 5.

17. A force measurement system, wherein the force measurement system is a force measurement system optimized by using the method according to claim 6.

18. A force measurement system, wherein the force measurement system is a force measurement system optimized by using the method according to claim 7.

19. A force measurement system, wherein the force measurement system is a force measurement system optimized by using the method according to claim 8.

20. A force measurement system, wherein the force measurement system is a force measurement system optimized by using the method according to claim 9.
